(19) United States
(12) Patent Application Publication
(10) Pub. No.: US 2025/0163274 A1
(43) Pub. Date: May 22, 2025

(54) WHITE UV-ABSORBING SURFACE-REACTED CALCIUM CARBONATE DOPED WITH A TITANIUM SPECIES

(71) Applicant: Omya International AG, Oftringen (CH)

(72) Inventors: Jamal FTOUNI, Zofingen (CH); Daniel Edward GERARD, Basel (CH)

(73) Assignee: Omya International AG, Oftringen (CH)

(21) Appl. No.: 18/867,958

(22) PCT Filed: May 23, 2023
(86) PCT No.: PCT/EP2023/063754

§ 371 Date: Nov. 21, 2024

(30) Foreign Application Priority Data
May 25, 2022 (EP) 22175456.7

(51) Int. Cl. C09C 1/02

(52) U.S. Cl. CPC C09C 1/022; C01P 2004/61; C01P 2006/12; C01P 2006/14

(57) ABSTRACT

The present invention refers to a white UV-absorbing surface-reacted calcium carbonate doped with a titanium species, comprising calcite and hydroxyapatite in a weight ratio of from 99:1 to 1:99 based on the dry weight of the calcite and the dry weight of the hydroxyapatite and having a specific surface area of from 15 m²/g to 200 m/²g, wherein the titanium species is present in an amount from 0.01 to 20 wt.-% of titanium element, based on the total dry weight of the surface-reacted calcium carbonate. Furthermore, the present invention refers to a process for producing the white UV-absorbing surface-reacted calcium carbonate doped with a titanium species, the use of said white UV-absorbing surface-reacted calcium carbonate doped with a titanium species as well as an article comprising said white UV-absorbing surface-reacted calcium carbonate doped with a titanium species.

The present invention refers to a white UV-absorbing surface-reacted calcium carbonate doped with a titanium species, comprising calcite and hydroxyapatite in a weight ratio of from 99:1 to 1:99 based on the dry weight of the calcite and the dry weight of the hydroxyapatite and having a specific surface area of from 15 m²/g to 200 m²/g, wherein the titanium species are present in an amount from 0.01 to 20 wt.-% of titanium element, based on the total dry weight of the surface-reacted calcium carbonate. Furthermore, the present invention refers to a process for producing the white UV-absorbing surface-reacted calcium carbonate doped with a titanium species, the use of said white UV-absorbing surface-reacted calcium carbonate doped with a titanium species as well as an article comprising said white UV-absorbing surface-reacted calcium carbonate doped with a titanium species.

### BACKGROUND

Mineral fillers and especially calcium carbonate—containing mineral fillers are often used as particulate fillers that are added to resin or binders, paints or papers and can improve specific properties such as, for example, opacity, brightness, stability, viscosity, strength or stiffness, and can make the product cheaper, or a mixture of both.

EP2997833 refers to the use of a surface-reacted calcium carbonate as anti-caking agent, wherein the surface-reacted calcium carbonate is a reaction product of natural ground or precipitated calcium carbonate with carbon dioxide and at least one acid in an aqueous medium, wherein the at least one acid is selected from the group consisting of hydrochloric acid, sulphuric acid, sulphurous acid, phosphoric acid, citric acid, oxalic acid, acetic acid, formic acid, and mixtures thereof, wherein the carbon dioxide is formed in situ by the acid treatment and/or is supplied from an external source and wherein the surface-reacted calcium carbonate particles have a volume median grain diameter d₅₀ of from 0.1 to 50 mm.

EP2926797 refers to an oral care composition for use in remineralisation and/or whitening of teeth, comprising a surface-reacted calcium carbonate, wherein the surface-reacted calcium carbonate is a reaction product of natural or synthetic calcium carbonate with carbon dioxide and at least one acid.

EP20186219.0 refers to a curable fluoropolymer composition comprising a crosslinkable fluorine-containing polymer, and surface-reacted calcium carbonate as filler.

In addition thereto often further pigments and particles are added that add further advantageous features to the filler composition. Pigments or particles are generally known as materials that change the colour of reflected or transmitted light as the result of wavelength-selective absorption. This physical process differs from fluorescence, phosphorescence, and other forms of luminescence, in which a material emits light. Pigments are used for colouring e.g. paint, ink, plastic, fabric, cosmetics, food and other materials. Most pigments used are dry colourants, usually ground into a fine powder.

White pigments take a special position in the field of pigments due to their industrial relevance. For example, in the paper industry in Europe more than 10 million tonnes per year of white pigments are used. White pigments are also used in paints and coatings. Especially when manufacturing dispersion paints, white pigments are the base colour in the tinting system.

A known white pigment is titanium dioxide which is also called titanium white, Pigment White 6 (PW6), Cl 77891, or E number E171. Generally, it is sourced from ilmenite, rutile, and anatase or a mixture. It has a wide range of applications, especially as white pigment in paper, and plastic materials but also in paint. Additionally, due to its white color it is also used as food coloring or in cosmetic applications. Furthermore, titanium dioxide is able to absorb in the UV range and, therefore is often used in sunscreens and sunscreen applications.

EP0634462 refers to coating compositions containing very finely divided TiO₂, comprising from 0.5 to 30.0% by volume of colour pigment and/or carbon black, from 55,0 to 98.5% by volume of binder solids and from 0.3 to 15.0% by volume of very finely divided TiO₂ with a particle size of from 5 to 40 nm, and having a high overall reflectance (luminance) and an intense depth of colour.

EP2188125 refers to a self-cleaning, de-polluting paint comprising from about 5% to about 40% by volume photocatalytic titanium dioxide in substantially pure anatase form, said photocatalytic titanium dioxide being characterized by an average crystallite size between about 5 nm and about 30 nm and having photocatalytic activity in the presence of visible light; one or more additional pigments, and a styrene acrylic copolymer binder.

U.S. Pat. No. 7,476,704 refers to a polymer composition comprising a polymer resin, a flash calcined kaolin clay filler and a titanium dioxide filler. The titanium dioxide has a median aggregate size in the range of from about 0.2 to 0.35 μm.

AU630406 refers to titanium dioxide particles having a mean primary particle size of less than 100 nm, each of said particles being substantially coated with phospholipids. The phospholipid-coated titanium dioxide particles may be incorporated into oil-in-water and water-in-oil emulsions to provide novel sunscreen compositions with excellent ultraviolet screening efficiency, long term stability and water-resistant properties.

EP3360601 refers to a cosmetic composition having UV-A and/or UV-B protection comprising at least one inorganic UV filter, and a surface-reacted calcium carbonate having a volume median particle size d₅₀ from 0.1 to 90 μm, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ on donors treatment and/or is supplied from an external source. However, in this patent application only a mixture of an inorganic UV filter and a surface-reacted calcium carbonate is provided but the structure of the surface-reacted calcium carbonate is not amended.

EP3517176 refers to the use of a surface-reacted calcium carbonate having a volume median particle size d₅₀ from 0.1 to 90 μm as skin appearance modifier in a cosmetic and/or skin care composition, wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source. EP3517178 refers to the use of a surface-reacted calcium carbonate in a cosmetic and/or skin care composition as an agent for modifying the biomechanical properties of the skin, wherein the surface-reacted calcium carbonate has a volume median particle size d₅₀ from 0.1 to 90 μm, and wherein the surface-reacted calcium carbonate is a reaction product of natural ground calcium carbonate or precipitated calcium carbonate with carbon dioxide and one or more H₃O⁺ ion donors, wherein the carbon dioxide is formed in situ by the H₃O⁺ ion donors treatment and/or is supplied from an external source. The cosmetic and/or skin care composition may comprise further additives such as inorganic UV filters, for example titanium dioxide. However, also these document refer only to mixtures of an inorganic UV filter and a surface-reacted calcium carbonate but the structure of the surface-reacted calcium carbonate is not amended.

However, in several applications the titanium dioxide is used in form of powders comprising submicrometer or nanometer size titanium dioxide particles. This is disadvantageous since TiO₂ powders in the submicron and/or nanometer size are a concern due to the potentially carcinogenic aspect of such small titanium dioxide particles. Due to this potential carcinogenicity there are attempts in the European Union to prohibit such particles at least in food and cosmetic applications.

Another drawback is that when both compounds, surface-reacted calcium carbonate and titanium dioxide, are mixed in form of dry products this may lead to dusting which may cause health issues, especially when inhaled. Furthermore, when both compounds, surface-reacted calcium carbonate and a titanium containing material (e.g. titanium dioxide), are mixed in form of dry products often particles separation occurs during transport due to PSD (particles size distribution) and density differences.

In view of the foregoing, there is an ongoing need for particles or fillers that comprises surface-reacted calcium carbonate as well as a titanium species and have excellent properties in view of their colour, their UV-absorbance as well as in view of their mechanical and particle properties.

Accordingly, it is an object of the present invention to provide an improved filler or improved particles that comprise surface-reacted calcium carbonate and can be used in polymer applications, paper coating applications, paper making, especially in décor paper making, paints, coatings, sealants, adhesives, feed, pharmaceuticals, concrete, cement, cosmetics, water treatment, engineered wood applications, plasterboard applications, packaging applications, catalysis, gas treatment applications and/or agricultural applications. The filler or particles should have a white appearance so that they can especially be used in paint and paper and do not add an unwanted colour to such applications.

Furthermore, it is desirably to provide fillers or particles that have UV-absorbing properties and can be used in pharmaceuticals or cosmetics especially in sunscreens and sunscreen applications.

The fillers or particles should be non-toxic to humans, do not provide a harmful effect on the environment and might be used in cosmetic applications. Especially, the fillers or particles should be free of titanium dioxide in the submicron and/or nanometer size range in order to avoid health issues especially carcinogenicity of such products.

Furthermore, it is desirable that the titanium species cannot be separated from the surface-reacted calcium carbonate by mere washing or in liquid compositions.

Another object of the present invention is that the fillers or particles should be easily and quickly produced, are affordable and especially easy to handle.

### SUMMARY OF THE INVENTION

The foregoing and other objects are solved by the subject-matter as defined in the independent claims.

According to one aspect of the present invention a process for producing a white UV-absorbing surface-reacted calcium carbonate doped with a titanium species is provided comprising the steps of:
a) providing a calcium carbonate-comprising material,
b) providing at least one H₃O⁺ ion donor,
c) providing at least one titanium comprising substance, and
d) treating the calcium carbonate-comprising material of step a) with the at least one H₃O⁺ ion donor of step b) in an aqueous medium to form an aqueous suspension of surface-reacted calcium carbonate, and

wherein the at least one titanium comprising substance of step c) is added before and/or during and/or after step d).

According to another aspect of the present invention a white UV-absorbing surface-reacted calcium carbonate doped with a titanium species, comprising calcite and hydroxyapatite and having a specific surface area of from 15 m²/g to 200 m²/g, measured using nitrogen and the BET method according to ISO 9277:2010, is provided, wherein the weight ratio of calcite to hydroxyapatite is from 99:1 to 1:99 based on the dry weight of the calcite and the dry weight of the hydroxyapatite, and wherein the titanium species is present in an amount from 0.01 to 20 wt % of titanium element, based on the total dry weight of the surface-reacted calcium carbonate.

The inventors surprisingly found out that by the inventive process it is possible to prepare surface-reacted calcium carbonate particles that are doped with a titanium species. The process for producing these particles is an easy and quick process and the obtained product is affordable and especially easy to handle. The process can be performed in standard equipment without significant burden for humans and environment. Such a process and product is advantageous since the end consumer has not to handle particles that comprise titanium dioxide in form of powders comprising submicrometer or nanometer size titanium dioxide particles. Rather, the obtained particles comprise the advantageous properties of the surface-reacted calcium carbonate and especially have a high surface area and furthermore, are of white colour and are UV-absorbing. The obtained white UV-absorbing surface-reacted calcium carbonate doped with a titanium species can be used in several applications such as, for example, paint, paper, coatings, catalysis or sunscreens. Such products have not to be labelled in the ingredient list with titanium dioxide particles in the submicron and/or nanometer size range and, therefore, should have a higher acceptance from the end consumer.

According to another aspect of the present invention the white UV-absorbing surface-reacted calcium carbonate doped with a titanium species according to the present invention is used in polymer applications, paper coating applications, paper making, especially in décor paper making, paints, coatings, sealants, adhesives, feed, pharmaceuticals, concrete, cement, cosmetics, water treatment, engineered wood applications, plasterboard applications, packaging applications, catalysis, gas treatment applications and/or agricultural applications.

According to another aspect of the present invention the white UV-absorbing surface-reacted calcium carbonate doped with a titanium species according to the present invention is used for sun protection of plants and parts thereof or for chemical and physical sun protection in a cosmetic formulation.

According to another aspect of the present invention an article comprising a white UV-absorbing surface-reacted calcium carbonate doped with a titanium species according to the present invention is provided, wherein the article is selected from paper products, engineered wood products, plasterboard products, polymer products, hygiene products, medical products, healthcare products, filter products, woven materials, nonwoven materials, geotextile products, agriculture products, horticulture products, clothing, footwear products, baggage products, household products, industrial products, packaging products, building products, and construction products.

Advantageous embodiments of the above aspects are defined in the corresponding sub-claims.

According to one embodiment of the present invention, the calcium carbonate-comprising material is a natural ground calcium carbonate and/or a precipitated calcium carbonate, preferably the natural ground calcium carbonate is selected from the group consisting of marble, chalk, limestone, and mixtures thereof, and/or the precipitated calcium carbonate is selected from the group consisting of precipitated calcium carbonates having an aragonitic, vateritic or calcitic crystal form, and mixtures thereof.

According to another embodiment of the present invention, the calcium carbonate-comprising material is in the form of particles having a weight median particle size d₅₀(wt) from 0.05 to 10 μm, preferably from 0.2 to 5.0 μm, more preferably from 0.4 to 3.0 μm, and most preferably from 0.6 to 1.2 μm, and/or a weight top cut particle size d3(wt) from 0.15 to 55 μm, preferably from 1 to 40 μm, more preferably from 2 to 25 μm, and most preferably from 3 to 15 μm.

According to another embodiment of the present invention, the at least one H₃O⁺ ion donor is selected from the group consisting of phosphoric acid, citric acid, an acidic salt, tartaric acid and mixtures thereof, preferably the at least one H₃O⁺ ion donor is selected from the group consisting of phosphoric acid, H₂PO₄, being at least partially neutralised by a cation selected from Lr⁺, Na⁺ and/or K+, HPO₄₂, being at least partially neutralised by a cation selected from Li⁺, Na⁺, K⁺, Mg⁺, and/or Ca²⁺, citric acid and mixtures thereof, more preferably the at least one H₃O⁺ ion donor is selected from the group consisting of phosphoric acid, citric acid, or mixtures thereof, and most preferably, the at least one H₃O⁺ ion donor is phosphoric acid.

According to another embodiment of the present invention, the molar ratio of the at least one H₃O⁺ ion donor to the calcium carbonate-comprising material is from 0.01 to 4, preferably from 0.02 to 2, more preferably from 0.05 to 1, and most preferably from 0.1 to 0.58.

According to another embodiment of the present invention, the at least one titanium comprising substance is selected from the group consisting of a titanium salt, a titanium hydroxide, a titanium oxide, and mixtures thereof, preferably the titanium comprising substance is selected from the group consisting of titanium bromide, titanium fluoride, titanium iodide, titanium chloride, titanyl sulfate, titanium hydroxide, titanium dioxide, and mixtures thereof and most preferably the titanium comprising substance is selected from titanium bromide, titanium fluoride, titanium iodide, titanium chloride, titanyl sulfate and mixtures thereof.

According to another embodiment of the present invention, the at least one titanium comprising substance is provided in an amount from 0.1 to 20 wt.-% of titanium element, based on the total dry weight of the calcium carbonate-comprising material, preferably from 0.5 to 15 wt.-%, more preferably from 1.0 to 10 wt.-%, and most preferably from 2.5 to 7.5 wt-%.

According to another embodiment of the present invention, in step d) the calcium carbonate-comprising material is treated with a solution comprising the at least one H₃O⁺ ion donor of step b) and the at least one titanium comprising substance of step c).

According to another embodiment of the present invention, in step d) the pH value of the obtained aqueous suspension of surface-reacted calcium carbonate is from 4.5 to 11, preferably from 5.5 to 10, and most preferably from 6.0 to 8.0.

According to another embodiment of the present invention, step d) is carried out at a temperature from 20 to 95° C., preferably from 30 to 85° C., more preferably from 40 to 80° C., even more preferably from 50 to 75° C., and most preferably from 65 to 73° C.

According to another embodiment of the present invention, the process further comprises a step e) of separating the white UV-white absorbing surface-reacted calcium carbonate doped with a titanium species from the aqueous suspension obtained in step d) and preferably step e) is done by solvent evaporation and/or pressure filtration and/or wherein the process further comprises a step f) of drying the surface-reacted calcium carbonate doped with a titanium species after step d) or after step e), if present, at a temperature in the range from 60 to 600° C., preferably from 80 to 450° C., most preferably from 95 to 400° C., preferably until the moisture content of the surface-reacted calcium carbonate doped with a titanium species is between 0.01 and 5 wt.-%, based on the total weight of the dried surface-reacted calcium carbonate.

According to another embodiment of the present invention, the surface-reacted calcium carbonate doped with a titanium species has
(i) a specific surface area of from 25 m²/g to 180 m²/g, more preferably from 30 m²/g to 160 m²/g, even more preferably from 45 m²/g to 150 m²/g, most preferably from 50 m²/g to 140 m²/g, measured using nitrogen and the BET method according to ISO 9277:2010 and/or
(ii) a volume determined median particle size d₅₀(vol) from 1 to 100 μm, preferably from 2 to 60 μm, more preferably from 3 to 40 μm, even more preferably from 4 to 30 μm, and most preferably from 5 to 15 μm, and/or
(iii) a volume determined top cut particle size d₉F(vol) from 2 to 150 μm, preferably from 4 to 100 μm, more preferably from 6 to 80 μm, even more preferably from 8 to 60 μm, and most preferably from 10 to 30 μm and/or
(iv) an intra-particle intruded specific pore volume in the range from 0.1 to 2.3 cm³/g, preferably from 0.2 to 2.0 cm³/g, more preferably from 0.4 to 1.8 cm³/g, and most preferably from 0.6 to 1.6 cm³/g, calculated from mercury porosimetry measurement.

According to another embodiment of the present invention, the weight ratio of calcite to hydroxyapatite in the surface-reacted calcium carbonate doped with a titanium species is from 80:20 to 20:80 based on the dry weight of the calcite and the dry weight of the hydroxyapatite, preferably from 70:30 to 30:70 and most preferably from 60:40 to 40:60 and/or the titanium species is present in an amount from 0.05 to 15 wt.-% of titanium element, based on the total dry weight of the surface-reacted calcium carbonate, preferably from 0.1 to 10 wt.-%, and most preferably from 0.5 to 5 wt.-%.

It should be understood that for the purposes of the present invention, the following terms have the following meanings:

A “white” pigment or “white” particle or “white” filler material in the meaning of the present invention is a solid inorganic coloring material having a defined chemical composition and a characteristic crystalline structure. Such a material is insoluble in water and, thus, results in a suspension when contacted with water. It has a white appearance when illuminated by daylight.

UV—absorbing” pigments or particles in the meaning of the present invention absorb at least some of the ultraviolet B (UV-B) radiation which ranges from 280 to 320 nm and/or the ultraviolet A (UV-A) radiation which ranges from >320 to 400 nm.

A “surface-reacted calcium carbonate” in the meaning of the present invention is a reaction product of natural ground calcium carbonate or precipitated calcium carbonate with one or more H₃O⁺ Ion donors. A “H₃O⁺ ion donor” in the context of the present invention is a Brönsted acid and/or an acid salt.

A “calcium carbonate-comprising material” in the meaning of the present invention is a mineral material or a synthetic material having a content of calcium carbonate of at least 80 wt.-%, preferably 85 wt-%, more preferably 90 wt-%, and most preferably 95 wt.-%, based on the total weight of the calcium carbonate-comprising material.

“Natural ground calcium carbonate” (GCC also known as GNCC) in the meaning of the present invention is a calcium carbonate obtained from natural sources, such as limestone, marble, or chalk, and processed through a wet and/or dry treatment such as grinding, screening and/or fractionating, for example, by a cyclone or classifier.

“Precipitated calcium carbonate” (PCC) in the meaning of the present invention is a synthesised material, obtained by precipitation following reaction of carbon dioxide and lime in an aqueous, semi-dry or humid environment or by precipitation of a calcium and carbonate ion source in water. PCC may be in the vateritic, calcitic or aragonitic crystal form. PCCs are described, for example, in EP2447213 A1, EP2524898 A1, EP2371766 A1, EP1712597 A1, EP1712523 A1, or WO2013142473 A1.

A “titanium comprising substance” in the meaning of the present invention is a substance that comprises titanium in form of ions or in form of covalent bondings having a oxidation number different to zero.

A surface-reacted calcium carbonate “doped” with a titanium species refers to a surface-reacted calcium carbonate wherein a titanium species is introduced in the structure of the surface-reacted calcium carbonate. The titanium species refers to titanium in oxidation numbers different to zero.

The “particle size” of particulate materials other than surface-reacted calcium carbonate (e g, GCC or PCC) herein is described by its distribution of particle sizes dₓ(1 wt). Therein, the value dₓ(wt) represents the diameter relative to which x % by weight of the particles have diameters less than dₓ(wt). This means that, for example, the dₓ(wt) value is the particle size at which 20 wt % of all particles are smaller than that particle size. The d₅₀(wt) value is thus the weight median particle size, i.e. 50 wt. % of all particles are smaller than that particle size and the da(wt) value, referred to as weight-based top cut, is the particle size at which 98 wt. % of all particles are smaller than that particle size. The weight-based median particle size d₅₀(wt) and top cut d₉₈(wt) are measured by the sedimentation method, which is an analysis of sedimentation behaviour in a gravimetric field. The measurement is made with a Sedigraph™ 5120 of Micromeritics Instrument Corporation, USA. The method and the instrument are known to the skilled person and are commonly used to determine particle size distributions. The measurement is carried out in an aqueous solution of 0.1 wt. % Na₄P₂O₇ The samples are dispersed using a high speed stirrer and sonication

The “particle size” of surface-reacted calcium carbonate herein is described as volume-based particle size distribution dₓ,(vol). Therein, the value dₓ(vol) represents the diameter relative to which x % by volume of the particles have diameters less than dₓ(vol). This means that, for example, the d₂₀(vol) value is the particle size at which 20 vol. % of all particles are smaller than that particle size. The d₅₀(vol) value is thus the volume median particle size, i.e. 50 vol. % of all particles are smaller than that particle size and the d₉₈(vol) value, referred to as volume-based top cut, is the particle size at which 98 vol. % of all particles are smaller than that particle size. Volume median particle size d₅₀ was evaluated using a Malvern Mastersizer 3000 Laser Diffraction System. The d₅₀ or des value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

For the purpose of the present invention the “porosity” or “pore volume” refers to the intra-particle intruded specific pore volume. In the context of the present invention, the term “pore” is to be understood as describing the space that is found between and/or within particles, i.e. that is formed by the particles as they pack together under nearest neighbour contact (interparticle pores), such as in a powder or a compact, and/or the void space within porous particles (intraparticle pores), and that allows the passage of liquids under pressure when saturated by the liquid and/or supports absorption of surface wetting liquids.

The specific pore volume is measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm. The equilibration time used at each pressure step is 20 s. The sample material is sealed in a 3 cm³ chamber powder penetrometer for analysis. The data are corrected for mercury compression, penetrometer expansion and sample material elastic compression using the software Pore-Comp (Gane, P. A. C., Kettle, J. P., Matthews, G. P. and Ridgway, C. J, “Void Space Structure of Compressible Polymer Spheres and Consolidated Calcium Carbonate Paper-Coating Formulations”, Industrial and Engineering Chemistry Research, 1996, 35(5), 1753-1764).

The total pore volume seen in the cumulative intrusion data is separated into two regions with the intrusion data from 214 μm down to about 1 to 4 μm. showing the coarse packing of the sample between any agglomerate structures contributing strongly. Below these diameters lies the fine interparticle packing of the particles themselves. If they also have intraparticle pores, then this region appears bimodal, and by taking the specific pore volume intruded by mercury into pores finer than the modal turning point, i.e. finer than the bimodal point of inflection, we thus define the specific intraparticle pore volume. The sum of these three regions gives the total overall pore volume of the powder, but depends strongly on the original sample compaction/settling of the powder at the coarse pore end of the distribution.

By taking the first derivative of the cumulative intrusion curve, the pore size distributions based on equivalent Laplace diameter, inevitably including pore-shielding, are revealed. The differential curves clearly show the coarse agglomerate pore structure region, the interparticle pore region and the intraparticle pore region, if present. Knowing the intraparticle pore diameter range it is possible to subtract the remainder interparticle and interagglomerate pore volume from the total pore volume to deliver the desired pore volume of the internal pores alone in terms of the pore volume per unit mass (specific pore volume). The same principle of subtraction, of course, applies for isolating any of the other pore size regions of interest.

Throughout the present document, the term “specific surface area” (in m²g), which is used to define functionalized calcium carbonate or other materials, refers to the specific surface area as determined by using the BET method (using nitrogen as absorbing gas). Throughout the present document, the specific surface area (in m²/g) is determined using the BET method (using nitrogen as absorbing gas), which is well known to the skilled man (ISO 9277:2010). The total surface area (in m²} of the filler material is then obtained by multiplication of the specific surface area and the mass (in g) of the corresponding sample.

For the purpose of the present application, “water-insoluble” materials are defined as materials which, when 100 g of said material is mixed with 100 g deionised water and filtered on a filter having a 0.2 μm pore size at 20° C. to recover the liquid filtrate, provide less than or equal to 1 g of recovered solid material following evaporation at 95 to 100° C. of 100 g of said liquid filtrate at ambient pressure. “Water-soluble” materials are defined as materials which, when 100 g of said material is mixed with 100 g deionised water and filtered on a filter having a 0.2 μm pore size at 20° C. to recover the liquid filtrate, provide more than 1 g of recovered solid material following evaporation at 95 to 100° C. of 100 g of said liquid filtrate at ambient pressure.

For the purpose of the present invention, the “solids content” of a liquid composition is a measure of the amount of material remaining after all the solvent or water has been evaporated. If necessary, the “solids content” of a suspension given in wt % in the meaning of the present invention can be determined using a Moisture Analyzer HR73 from Mettler-Toledo (T=120° C., automatic switch off 3, standard drying) with a sample size of 5 to 20 g.

Unless specified otherwise, the term “drying” refers to a process according to which at least a portion of water is removed from a material to be dried such that a constant weight of the obtained “dried” material at 220° C. is reached. The term “dry” material or “dry” composition, is understood to be a material/composition having less than 1.0% by weight of water relative to the material/composition weight. The % water (equal to residual total moisture content) is determined according to the Coulometric Karl Fischer measurement method. wherein the material/composition is heated to 220° C., and the water content released as vapour and isolated using a stream of nitrogen gas (at 100 ml/min) is determined in a Coulometric Karl Fischer unit.

For the purpose of the present invention, the term “viscosity” or “Brookfield viscosity” refers to Brookfield viscosity. The Brookfield viscosity is for this purpose measured by a Brookfield DV-li+ Pro viscometer at 25°±1° 0 at 100 rpm using an appropriate spindle of the Brookfield RV-spindle set and is specified in mPa-s. Based on his technical knowledge, the skilled person will select a spindle from the Brookfield RV-spindle set which is suitable for the viscosity range to be measured. For example, for a viscosity range between 200 and 800 mPa-s the spindle number 3 may be used, for a viscosity range between 400 and 1 600 mPa-s the spindle number 4 may be used, for a viscosity range between 800 and 3 200 mPa-s the spindle number 5 may be used, for a viscosity range between 1 000 and 2 000 000 mPa-s the spindle number 6 may be used, and for a viscosity range between 4 000 and 8 000 000 mPa-s the spindle number 7 may be used.

A “suspension” or “slurry” in the meaning of the present invention comprises undissolved solids and water, and optionally further additives, and usually contains large amounts of solids and, thus, is more viscous and can be of higher density than the liquid from which it is formed.

Where an indefinite or definite article is used when referring to a singular noun, e g., “a”, “an” or“the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising” If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

### DETAILED DESCRIPTION OF THE INVENTION

The inventive process for producing the white UV-absorbing surface-reacted calcium carbonate doped with a titanium species comprises the steps of a) providing a calcium carbonate-comprising material, b) providing at least one H₃O⁺ ion donor, c) providing at least one titanium comprising substance, and d) treating the calcium carbonate-comprising material of step a) with the at least one H₃O⁺ on donor of step b) in an aqueous medium to form an aqueous suspension of surface-reacted calcium carbonate, and wherein the at least one titanium comprising substance of step c) is added before and/or during and/or after step d).

In the following preferred embodiments of the inventive white UV-absorbing surface-reacted calcium carbonate doped with a titanium species will be set out in more detail. It is to be understood that these embodiments and details also apply to the inventive products and uses thereof as well as to the inventive process for preparing said white UV-absorbing surface-reacted calcium carbonate doped with a titanium species.

### Process Step a)

According to step a) of the process of the present invention, a calcium-carbonate comprising material is provided.

According to one embodiment the at least one calcium carbonate-comprising material has a content of calcium carbonate of at least 80 wt.-%, preferably 85 wt.-%, more preferably 90 wt.-%, and most preferably 95 wt.-%, based on the total weight of the calcium carbonate-comprising material.

According to another embodiment the at least one calcium carbonate comprising material consists of calcium carbonate.

The calcium carbonate-comprising material may be selected from natural ground calcium carbonate, precipitated calcium carbonate, or mixtures thereof. The natural ground calcium carbonate may be preferably selected from marble, limestone and/or chalk, and/or the precipitated calcium carbonate may be preferably selected from vaterite, calcite arid/or aragonite.

According to one embodiment of the present invention, the calcium carbonate-comprising material is a natural ground calcium carbonate and/or a precipitated calcium carbonate, preferably the natural ground calcium carbonate is selected from the group consisting of marble, chalk, limestone, and mixtures thereof, and/or the precipitated calcium carbonate is selected from the group consisting of precipitated calcium carbonates having an aragonitic, vateritic or calcitic: crystal form, and mixtures thereof.

“Natural ground calcium carbonate” (GCC) is understood to be manufactured from a naturally occurring form of calcium carbonate, mined from sedimentary rocks such as limestone or chalk, or from metamorphic marble rocks, eggshells or seashells. Calcium carbonate is known to exist as three types of crystal polymorphs: calcite, aragonite and vaterite. Calcite, the most common crystal polymorph, is considered to be the most stable crystal form of calcium carbonate. Less common is aragonite, which has a discrete or clustered needle orthorhombic crystal structure. Vaterite is the rarest calcium carbonate polymorph and is generally unstable. Ground calcium carbonate is almost exclusively of the calcitic polymorph, which is said to be trigonal-rhombohedral and represents the most stable form of the calcium carbonate polymorphs. The term “source” of the calcium carbonate in the meaning of the present application refers to the naturally occurring mineral material from which the calcium carbonate is obtained. The source of the calcium carbonate may comprise further naturally occurring components such as magnesium carbonate, alumino silicate etc.

In general, the grinding of natural ground calcium carbonate may be a dry or wet grinding step and may be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulverizer, a shredder, a de-clumper, a knife cutter, or other such equipment known to the skilled man. In case the calcium carbonate containing mineral material comprises a wet ground calcium carbonate containing mineral material, the grinding step may be performed under conditions such that autogenous grinding takes place and/or by horizontal ball milling, and/or other such processes known to the skilled man. The wet processed ground calcium carbonate containing mineral material thus obtained may be washed and dewatered by well-known processes, e.g. by flocculation, filtration or forced evaporation prior to drying. The subsequent step of drying (if necessary) may be carried out in a single step such as spray drying, or in at least two steps. It is also common that such a mineral material undergoes a beneficiation step (such as a flotation, bleaching or magnetic separation step) to remove impurities.

According to one embodiment of the present invention the source of natural ground calcium carbonate (GCC) is selected from marble, chalk, limestone, or mixtures thereof. Preferably, the source of ground calcium carbonate is marble, and more preferably magnesitic marble. According to one embodiment of the present invention the GCC is obtained by dry grinding. According to another embodiment of the present invention the GCC is obtained by wet grinding and subsequent drying.

According to one embodiment of the present invention, the calcium carbonate comprises one type of natural ground calcium carbonate. According to another embodiment of the present invention, the calcium carbonate comprises a mixture of two or more types of natural ground calcium carbonates selected from different sources.

“Precipitated calcium carbonate” (PCC) in the meaning of the present invention is a synthesized material, generally obtained by precipitation following reaction of carbon dioxide and calcium hydroxide in an aqueous environment or by precipitation of calcium and carbonate ions for example CaCl₂ and Na₂CO₃, out of solution. Further possible ways of producing PCC are the lime soda process, or the Solvay process in which PCC is a by-product of ammonia production.

Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained PCC slurry can be mechanically dewatered and dried.

According to one embodiment of the present invention, the calcium carbonate is precipitated calcium carbonate, preferably comprising aragonitic, vateritic or calcitic mineralogical crystal forms or mixtures thereof.

Precipitated calcium carbonate may be ground prior to the treatment with at least one H₃O⁺ ion donor by the same means as used for grinding natural ground calcium carbonate as described above.

According to one embodiment of the present invention, the calcium carbonate-comprising material is in form of particles having a weight median particle size d₅₀(wt) from 0.05 to 10 μm, preferably from 0.2 to 5.0 μm, more preferably from 0.4 to 3.0 μm, and most preferably from 0.6 to 1.2 ₚm, especially 0.7 μm. According to a further embodiment of the present invention, the calcium carbonate-comprising material is in form of particles having a top cut particle size des(wt) of 0.15 to 55 μm, preferably 1 to 40 μm, more preferably 2 to 25 μm, and most preferably 3 to 15 μm, especially 4 μm.

The calcium carbonate-comprising material may have a specific surface area (BET) from 1 to 200 m²/g, as measured using nitrogen and the BET method according to ISO 9277:2010. According to one embodiment the specific surface area (BET) of the calcium carbonate-comprising material is from 1 to 150 m²/g, preferably from 2 to 60 m²/g, and more preferably from 2 to 15 m²/g, as measured using nitrogen and the BET method according to ISO 9277:2010.

The calcium carbonate-comprising material may be used dry or in form of an aqueous suspension. According to a preferred embodiment, the calcium carbonate-comprising material is in form of an aqueous suspension having a solids content within the range of 1 wt.-% to 90 wt-%, preferably 3 wt-% to 60 wt.-%, more preferably 5 wt.-% to 40 wt.-%, and most preferably 10 wt-% to 25 wt.-%, based on the weight of the aqueous suspension.

The term ° aqueous' suspension refers to a system, wherein the liquid phase comprises, preferably consists of, water However, said term does not exclude that the liquid phase of the aqueous suspension comprises minor amounts of at least one water-miscible organic solvent selected from the group comprising methanol, ethanol, acetone, acetonitrile, tetrahydrofuran and mixtures thereof. If the aqueous suspension comprises at least one water-miscible organic solvent, the liquid phase of the aqueous suspension comprises the at least one water-miscible organic solvent in an amount of from 0.1 to 40.0 wt.-% preferably from 0.25 to 30.0 Nt.-%, more preferably from 0.5 to 20.0 wt.-% and most preferably from 1.0 to 10.0 wt.-%, based on the total weight of the liquid phase of the aqueous suspension. For example, the liquid phase of the aqueous suspension consists of water.

According to a preferred embodiment of the present invention, the aqueous suspension consists of water and the calcium carbonate-comprising material.

Alternatively, the aqueous suspension of the calcium carbonate-comprising material may comprise further additives, for example, a dispersant. A suitable dispersant may be selected from polyphosphates, and is in particular a tripolyphosphate. Another suitable dispersant may be selected from the group comprising homopolymers or copolymers of polycarboxylic acid salts based on, for example, acrylic acid, methacrylic acid, maleic acid, fumaric acid or itaconic acid and acrylamide or mixtures thereof. The homopolymers or copolymers of polycarboxylic acid salts can be fully or partially neutralized, for example, at least 70%, or at least 80% or at least 90% of the acid groups are neutralized. Neutralizing means that the protons of the carboxylic acids are exchanged with another cation Such as sodium and/or calcium cations. According to a preferred embodiment, the homopolymers or copolymers of polycarboxylic acid salts are fully neutralized and most preferably are fully neutralized with sodium and/or calcium ions. Homopolymers or copolymers of acrylic acid are especially preferred. Most preferred are homopolymers or copolymers of acrylic acid that are fully neutralized with sodium and/or calcium ions. The weight average molecular weight M, of such products is preferably in the range from 2 000 to 15 000 g/mol, with a weight average molecular weight MW from 3 000 to 7 000 g/mol or 3 500 to 6 000 g/mol being especially preferred. According to an exemplary embodiment, the dispersant is sodium polyacrylate having a weight average molecular weight MW from 2 000 to 15 000 g/mol, preferably from 3 000 to 7 000 g/mol, and most preferably from 3 500 to 6 000 g/mol.

According to one embodiment of the present invention, the calcium carbonate-comprising material provided in process step a) is natural ground calcium carbonate and/or precipitated calcium carbonate, preferably an aqueous suspension of natural ground calcium carbonate and/or precipitated calcium carbonate having a solids content within the range of 1 wt.-% to 90 wt.-%, preferably 3 wt.-% to 60 wt.-%, more preferably 5 wt.-% to 40 wt.-%, and most preferably 10 wt.-% to 25 wt.-%, based on the weight of the aqueous suspension.

### Process Step b)

According to step b) of the process of the present invention, at least one H₃O⁺ ion donor is provided. An “H₃O⁺ ion donor” in the context of the present invention is a Brönsted acid and/or an acid salt, i.e. a salt containing an acidic hydrogen.

The at least one H₃O⁺ ion donor may be any medium-strong acid, or weak acid, or a mixture thereof, generating H₃O⁺ ions under the preparation conditions. According to the present invention, the at least one H₃O⁺ ion donor can also be an acid salt, generating H₃O⁺ ions under the preparation conditions. According to the present invention the at least one H₃O⁺ ion donor is not a strong acid, which has a pK, of less than 0. Such strong acids are known to the skilled person, for example, sulphuric acid or hydrochloric acid.

According to one embodiment, the at least one H₃O⁺ ion donor is a medium-strong acid having a pKa value from 0 to 2.5 at 20° C. If the pKa at 20° C. is from 0 to 2.5, the H₃O⁺ ion donor is preferably H₃PO₄. The at least one H₃O⁺ ion donor can also be an acid salt, for example, H₂PO₄⁻, being at least partially neutralized by a corresponding cation such as Li⁺, Na⁺ or K⁺, or HP₄²; being at least partially neutralised by a corresponding cation such as Li⁺, Na⁺, K⁺, Mg²⁺ or Ca²⁺ The at least one H₃O⁺ ion donor can also be a mixture of one or more acids and one or more acid salts.

According to another embodiment, the at least one H₃O⁺ ion donor is a weak acid having a pKₐ value of greater than 2.5 and less than or equal to 7, when measured at 20° C., associated with the ionisation of the first available hydrogen, and having a corresponding anion, which is capable of forming water-soluble calcium salts. Subsequently, at least one water-soluble salt, which in the case of a hydrogen-containing salt has a pKa of greater than 7, when measured at 20° C., associated with the ionisation of the first available hydrogen, and the salt anion of which is capable of forming water-insoluble calcium salts, is additionally provided. According to the preferred embodiment, the weak acid has a pKa value from greater than 2.5 to 5 at 20° C., and more preferably the weak acid is selected from the group consisting of citric acid, propanoic acid, tartaric acid and mixtures thereof. Exemplary cations of said water-soluble salt are selected from the group consisting of potassium, sodium, lithium and mixtures thereof. In a more preferred embodiment, said cation is sodium or potassium. Exemplary anions of said water-soluble salt are selected from the group consisting of phosphate, dihydrogen phosphate, monohydrogen phosphate, mixtures thereof and hydrates thereof. In a more preferred embodiment, said anion is selected from the group consisting of dihydrogen phosphate, monohydrogen phosphate, mixtures thereof and hydrates thereof. Water-soluble salt addition may be performed dropwise or in one step. In the case of drop wise addition, this addition preferably takes place within a time period of 10 minutes. It is more preferred to add said salt in one step.

According to one embodiment of the present invention, the at least one H₃O⁺ ion donor is selected from the group consisting of, phosphoric acid, citric acid, an acidic salt, and mixtures thereof Preferably the at least one H₃O⁺ ion donor is selected from the group consisting of phosphoric acid, H₂PO₄, being at least partially neutralised by a cation selected from Li⁺, Na⁺ and/or K⁺, HPO₄²⁻, being at least partially neutralised by a cation selected from Li⁺, Na⁺, K⁺, Mg²⁺, and/or Ca²⁺, citric acid and mixtures thereof, more preferably the at least one H₃O⁺ ion donor is selected from the group consisting of phosphoric acid, citric acid or mixtures thereof, and most preferably, the at least one H₃O⁺ ion donor is phosphoric acid.

The at least one H₃O⁺ ion donor can be provided in solid form or in form of a solution. According to a preferred embodiment, the at least one H₃O⁺ ion donor is provided in form of a solution.

According to one embodiment the at least one H₃O⁺ ion donor is provided in form of an aqueous solution comprising the at least one H₃O⁺ ion donor in an amount from 0.1 to 100 wt. %, based on the total weight of the aqueous solution, preferably in an amount from 1 to 80 wt.-%, more preferably in an amount from 10 to 50 wt.-%, and most preferably in an amount from 20 to 40 wt-%.

According to one embodiment, the molar ratio of the at least one H₃O⁺ ion donor to the calcium carbonate-comprising material is from 0.01 to 4, preferably from 0.02 to 2, more preferably from 0.05 to 1, and most preferably from 0.1 to 0.58.

According to another embodiment, the at least one H₃O⁺ ion donor is provided in an amount from 1 to 40 wt.-%, based on the total weight of the calcium carbonate-comprising material, preferably from 5 to 30 wt.-%, more preferably from 10 to 20 wt.-%, and most preferably from 15 to 18 wt.-%.

As an alternative it is also possible to add the H+30 ion donor to the water before the calcium carbonate-comprising material is added.

Process step c)

According to step c) of the process of the present invention at least one titanium comprising substance is provided.

According to one embodiment of the present invention the at least one titanium comprising substance is selected from the group consisting of a titanium salt, a titanium hydroxide, a titanium dioxide, and mixtures thereof.

According to a preferred embodiment of the present invention, the titanium comprising substance is selected from the group consisting of titanium bromide, titanium fluoride, titanium iodide, titanium chloride, titanyl sulfate, titanium hydroxide, titanium dioxide, and mixtures thereof and most preferably the titanium comprising substance is selected from titanium bromide, titanium fluoride, titanium iodide, titanium chloride, titanyl sulfate and mixtures thereof.

A “titanium salt” in the meaning of the present invention is a chemical compound consisting of an ionic assembly of cations (positively charged ions) comprising titanium and anions (negatively charged ions) so that the product is electrically neutral (without a net charge).

The anions can be inorganic anions, for example chloride (Cl⁻), bromide (Br⁻), fluoride (F⁻), iodide (I⁻), sulfate (SO²⁻₄), or nitrate (NO₃⁻), or organic anions, for example acetate (CH₃CO⁻₂).

The cations can be titanium cations, for example Ti²⁺, T³⁺ or Ti⁴⁺ cations.

Examples of suitable titanium salts are titanium bromide, for example TiBr₄ or TIBr₃, titanium fluoride, for example TiF₄ or TiF₃, titanium iodide (Til₄), titanium chloride (TiCl₄), titanyl sulfate (TiOSO₄) also known as titaniumoxysulafonate, titanium sulfate (Ti₂(SO₄)₃), titanium nitrate (Ti(NO₃)₄) or titanium acetate (Ti(C₂H₃O₂)₄). The titanium salt may be an anhydrous salt or a hydrate salt.

As used herein, a “hydrate” is an inorganic salt containing water molecules combined in a definite ratio as an integral part of the crystal. Depending on the number of water molecules per formula unit of salt, the hydrate may be designated as monohydrate, dihydrate, trihydrate, tetrahydrate, pentahydrate, hexahydrate, heptahydrate, octahydrate, nonahydrate, decahydrate, hemihydrates, etc.

“Titanium hydroxides” in the meaning of the present invention are chemical compounds comprising a diatomic anion with chemical formula OH⁻. The hydroxide consists of an oxygen and hydrogen atom held together by a single covalent bond, and carries a negative electric charge. Examples of suitable titanium hydroxides are Ti(OH)₄ or Ti(OH)₃.

“Titanium dioxides” in the meaning of the present invention are chemical compounds comprising titanium and oxygen, wherein the oxygen has the oxidation number (II). Examples of suitable titanium dioxides are TiO₂, TiO, Ti₂O₃, Ti₃O or Ti₂O, δ-TiOₓ wherein x=0.68⁻0.75 or TiₙO₂ₙ₋₁ where n ranges from 3 to 9 inclusive.

According to a preferred embodiment the titanium comprising substance is selected from the group consisting of titanium bromide, titanium fluoride, titanium iodide, titanium chloride, titanyl sulfate, titanium hydroxide, titanium dioxide, and mixtures thereof and most preferably the titanium comprising substance is selected from titanium bromide, titanium fluoride, titanium iodide, titanium chloride, titanyl sulfate and mixtures thereof and most preferably the titanium comprising substance is titanyl sulfate.

The titanium comprising substance can be a water-soluble or water-insoluble substance.

According to one embodiment the at least one titanium comprising substance is provided in an amount from 0.1 to 20 wt.-%, of titanium element, based on the total weight of the calcium carbonate-comprising material, preferably from 0.5 to 15 wt.-%, more preferably from 1 0 to 10 wt.-%, and most preferably from 2.5 to 7.5 wt.-%. The term “titanium element” in the meaning of the present invention refers to the weight of the titanium in the titanium comprising substance, assuming that the titanium is present as TP, also known as elemental titanium in the titanium comprising substance.

According to another embodiment the at least one titanium comprising substance is provided in an amount from 0.1 to 20 mol.-%, of titanium, based on the total amount of the calcium carbonate-comprising material, preferably from 0.5 to 15 mol.-%, more preferably from 1.0 to 10 moi.-%, and most preferably from 2.5 to 7.5 mol.-%.

The at least one titanium comprising substance can be provided in form of a solution, a suspension or as a dry material.

According to one embodiment the at least one titanium comprising substance is provided as dry material. The dry material may be in the form of powder, flakes, granules etc. and most preferably is in the form of a powder.

According to another embodiment the at least one titanium comprising substance is provided in form of an solution or suspension. Preferably, the solution or suspension comprises the at least one titanium comprising substance in an amount from 0.01 to 10 wt.-%, based on the total weight of the solution or suspension, preferably in an amount from 0.1 to 8 wt-%, more preferably in an amount from 0.4 to 5 wt.-%, and most preferably in an amount from 0.8 to 2 wt.-%.

The solution or suspension may be an aqueous solution or suspension, or an organic solution or suspension. Alternatively the solution or suspension may comprise both, water and an organic solvent that is miscible with water in any ratio, preferably the ratio of water: solvent is from 100:0.1 to 100:200, preferably from 100:1 to 100:150, more preferably from 100⁻5 to 100:120 and most preferably from 100:10 to 100:100, based on the weight of the water and the dry weight of the solvent. Possible organic solvents for the present invention are, for example, methanol, ethanol, ethylene glycol, glycerol, acetone, or propanol.

According to a preferred embodiment the solution or suspension is an aqueous solution or suspension that comprises, preferably consists of water and the titanium comprising substance.

### Process Step d)

According to step d) of the process of the present invention, the calcium carbonate-comprising material of step a) is treated with the at least one H₃O⁺ ion donor of step b) in an aqueous medium to form a suspension of surface-reacted calcium carbonate, and wherein the at least one titanium comprising substance of step c) is added before and/or during and/or after step d).

The calcium carbonate-comprising material can be treated with the at least one H₃O⁺ ion donor by providing an aqueous suspension of the calcium carbonate-comprising material and adding the at least one H₃O⁺ ion donor to said suspension. The at least one H₃O⁺ ion donor can be added to the suspension as a concentrated solution or a more diluted solution. As an alternative, itis also possible to treat the calcium carbonate-comprising material with the at least one H₃O⁺ ion donor by adding the calcium carbonate-comprising material to a solution of the at least one H₃O⁺ ion donor.

H₃O⁺ ion donor treatment can be carried out with a medium-strong acid. It is also possible to carry out H₃O⁺ ion donor treatment with a medium-strong acid having a pK₂ in the range of 0 to 2.5 at 20° C.

In a preferred embodiment, the H₃O⁺ ion donor treatment step is repeated at least once, more preferably several times. According to one embodiment, the at least one H₃O⁺ ion donor is added over a time period of at least about 5 min, preferably at least about 10 min, typically from about 10 to about min, more preferably about 30 min, even more preferably about 45 min, and sometimes about 1 h or more.

Subsequent to the H₃O⁺ ion donor treatment, the pH of the aqueous suspension, measured at 20° C., naturally reaches a value of greater than 6.0, preferably greater than 6 5, more preferably greater than 7.0, even more preferably greater than 7.5, thereby preparing the surface—reacted natural or precipitated calcium carbonate as an aqueous suspension having a pH of greater than 6.0, preferably greater than 6.5, more preferably greater than 7.0, even more preferably greater than 7.5.

In a particular preferred embodiment the surface reacted calcium carbonate is a reaction product of natural ground calcium carbonate (GNCC) with phosphoric acid.

Further details about the preparation of the surface-reacted natural calcium carbonate are disclosed in WO0039222 A1, WO2004083316 A1, WO2005121257 A2, WO2009074492 A1, EP2264108 A1, EP2264109 A1 and US20040020410 A1, the content of these references herewith being included in the present application.

Similarly, surface-reacted precipitated calcium carbonate is obtained. As can be taken in detail from WO2009074492 A1, surface-reacted precipitated calcium carbonate is obtained by contacting precipitated calcium carbonate with H₃O⁺ ions and with anions being solubilized in an aqueous medium and being capable of forming water-insoluble calcium salts, in an aqueous medium to form a slurry of surface-reacted precipitated calcium carbonate, wherein said surface-reacted precipitated calcium, carbonate comprises an insoluble, at least partially crystalline calcium, salt of said anion formed on the surface of at least part of the precipitated calcium carbonate.

Said solubilized calcium ions correspond to an excess of solubilized calcium ions relative to the solubilized calcium ions naturally generated on dissolution of precipitated calcium carbonate by H₃O⁺ ions, where said H₃O⁺ ions are provided solely in the form of a counterion to the anion, i.e. via the addition of the anion in the form of an acid or non-calcium acid salt, and in absence of any further calcium ion or calcium ion generating source.

Said excess solubilized calcium ions are preferably provided by the addition of a soluble neutral or acid calcium salt, or by the addition of an acid or a neutral or acid non-calcium salt which generates a soluble neutral or acid calcium salt in situ.

Said H₃O⁺ ions may be provided by the addition of an acid or an acid salt of said anion, or the addition of an acid or an acid salt which simultaneously serves to provide all or part of said excess solubilized calcium ions.

The at least one titanium comprising substance of step c) is added before and/or during and/or after step d). According to a preferred embodiment of the present invention the at least one titanium comprising substance of step c) is added before and/or during step d) and most preferably, the at least one titanium comprising substance of step c) is added during step d).

In case the at least one titanium comprising substance of step c) is added after step d) the at least one H₃O⁺ ion donor of step b) is still present in the solution. In case the at least one titanium comprising substance of step c) is added before step d) the at least one titanium comprising substance of step c) is still present in the solution when the H₃O⁺ ion donor of step b) is added During the inventive process the at least one H₃O⁺ ion donor and the at least one titanium comprising substance are simultaneously present in the composition comprising the calcium carbonate comprising material and/or the surface-reacted calcium carbonate. Without wishing to be bound by theory the inventors are of the opinion that the simultaneous presence of the at least one H₃O⁺ ion donor and the at least one titanium comprising substance results in the doping of the surface-reacted calcium carbonate with a titanium species. Therefore, this process differs from mixing a surface-reacted calcium carbonate that has already been formed with at least one titanium comprising substance without the presence of at least one H₃O⁺ ion donor, which results in a mere mixing, even in an aqueous suspension, and will not lead to a doped material.

According to a preferred embodiment, a process for producing a white UV-absorbing surface—reacted calcium carbonate doped with a titanium species is provided comprising the steps of:
a) providing a calcium carbonate-comprising material,
b) providing at least one H₃O⁺ ion donor,
c) providing at least one titanium comprising substance, and
d) treating the calcium carbonate-comprising material of step a) with the at least one H₃O⁺ ion donor of step b) in an aqueous medium to form an aqueous suspension of surface-reacted calcium carbonate, and
wherein the at least one titanium comprising substance of step c) is added before and/or during step d).

According to one embodiment of the present invention in a first step the at least one H₃O⁺ ion donor of step b) is added to the calcium carbonate comprising material of step a) and afterwards the titanium comprising substance of step c) is added.

According to another embodiment of the present invention in a first step the titanium comprising substance of step c) is added to the calcium carbonate comprising material of step a) and afterwards the at least one H₃O⁺ ion donor of step b) is added.

According to another embodiment of the present invention the titanium comprising substance of step c) is added to the calcium carbonate comprising material of step a) together with the at least one H₃O⁺ ion donor of step b).

According to one embodiment of the present invention the at least one H₃O⁺ ion donor of step b) and/or the at least one titanium comprising substance of step c) are added in form of a solid or in form of a solution. Preferably, the at least one H₃O⁺ ion donor of step b) and/or the at least one titanium comprising substance of step c) are added in form. of a solution. More preferably, the at least one H₃O⁺ ion donor of step b) and the at least one titanium comprising substance of step c) are added both in form of a solution.

The least one H₃O⁺ ion donor of step b) and the at least one titanium comprising substance of step c) may be provided in form of separate solutions and/or in form of combined solutions. According to one embodiment, in step d) the calcium carbonate-comprising material is treated with a solution comprising the at least one H₃O⁺ ion donor of step b) and the at least one titanium comprising substance of step c).

According to another embodiment, in step d) the calcium carbonate-comprising material is treated with a first solution comprising a first part of the at least one H₃O⁺ ion donor of step b), and subsequently, with a second solution comprising the remaining part of the at least one H₃O⁺ ion donor of step b) and the at least one titanium comprising substance of step c). The first solution may comprise less than or equal to 50 wt.-% of the at least one H₃O⁺ ion donor, based on the total amount of the at least one H₃O⁺ ion donor, preferably less than or equal to 40 wt.-%, more preferably less than or equal to 30 wt.-%, and most preferably less than or equal to 20 wt-%. For example, the first solution may comprise from 0.1 to 50 wt.-% of the at least one H₃O⁺ ion donor, based on the total amount of the at least one H₃O⁺ ion donor, preferably from 1 to 40 wt-%, more preferably from 5 to 30 wt.-%, and most preferably from 10 to 20 wt-%.

According to still another embodiment, in step b) a first H₃O⁺ ion donor and a second H₃O⁺ ion donor are provided, and in step d) the calcium carbonate—comprising material is treated with a first solution comprising the first H₃O⁺ ion donor, and subsequently, with a second solution comprising the second H₃O⁺ ion donor and the at least one titanium comprising substance of step c).

According to one embodiment in step d) the calcium carbonate-comprising material is treated with a first solution comprising a first part of the at least one H₃O⁺ ion donor of step b), and subsequently, with a second solution comprising the remaining part of the at least one H₃O⁺ ion donor of step b) and the at least one titanium comprising substance of step c), wherein the first solution comprises less than 50 wt.-% of the at least one H₃O⁺ ion donor, based on the total amount of the at least one H₃O⁺ on donor, preferably less than 40 wt-%, more preferably less than 30 wt.-%, and most preferably less than 20 wt-%.

According to a preferred embodiment in step d) the calcium carbonate-comprising material is treated with a solution comprising the at least one H₃O⁺ ion donor in an amount from 1 to 80 wt-%, preferably in an amount from 2 to 50 wt.-%, more preferably in an amount from 5 to 35 wt.-%, and most preferably in an amount from 10 to 30 wt.-%, based on the total weight of the aqueous solution.

Alternatively, according to another preferred embodiment in step d) the calcium carbonate-comprising material is treated with a solution comprising the at least one titanium comprising substance in an amount from 0.01 to 10 wt-% titanium element, preferably in an amount from 0.1 to 8 wt.-%, more preferably in an amount from 0.4 to 5 wt.-%, and most preferably in an amount from 0.8 to 2 wt.-%, based on the total weight of the aqueous solution.

According to a preferred embodiment in step d) the calcium carbonate-comprising material is treated with a solution comprising the at least one H₃O⁺ ion donor in an amount from 1 to 80 wt-%, preferably in an amount from 2 to 50 wt.-%, more preferably in an amount from 5 to 35 wt.-%, and most preferably in an amount from 10 to 30 wt.-%, based on the total weight of the aqueous solution and the at least one titanium comprising substance in an amount from 0.01 to 10 wt.-%, preferably in an amount from 0.1 to 8 wt-%, more preferably in an amount from 0.4 to 5 wt.-%, and most preferably in an amount from 0.8 to 2 wt.-%, based on the total weight of the aqueous solution.

According to a preferred embodiment, the calcium carbonate-comprising material is a natural ground calcium carbonate, the at least one H₃O⁺ ion donor is phosphoric acid and/or citric acid, and the at least one titanium comprising substance is selected from the group consisting of a titanium salt, a titanium hydroxide, a titanium oxide, and mixtures thereof, preferably the titanium comprising substance is selected from the group consisting of titanium bromide, titanium fluoride, titanium iodide, titanium chloride, titanyl sulfate, titanium hydroxide, titanium dioxide, and mixtures thereof and most preferably the titanium comprising substance is selected from titanium bromide, titanium fluoride, titanium iodide, titanium chloride, titanyl sulfate and mixtures thereof.

According to another preferred embodiment, the calcium carbonate-comprising material is a natural ground calcium carbonate, the at least one H₃O⁺ ion donor is phosphoric acid, and the at least one titanium comprising substance is selected from the group consisting of a titanium salt, a titanium hydroxide, a titanium oxide, and mixtures thereof, preferably the titanium comprising substance is selected from the group consisting of titanium bromide, titanium fluoride, titanium oxide, titanium chloride, titanyl sulfate, titanium hydroxide, titanium dioxide, and mixtures thereof, even more preferably the titanium comprising substance is selected from titanium bromide, titanium fluoride. titanium iodide, titanium chloride, titanyl sulfate and mixtures thereof and most preferably, the titanium comprising substance is titanyl sulfate.

According to a preferred embodiment, the calcium carbonate-comprising material is a natural ground calcium carbonate, the at least one H₃O⁺ ion donor is phosphoric acid and/or citric acid, and the at least one titanium comprising substance is selected from the group consisting of a titanium salt, a titanium hydroxide, a titanium oxide, and mixtures thereof, preferably the titanium comprising substance is selected from the group consisting of titanium bromide, titanium fluoride, titanium iodide, titanium chloride, titanyl sulfate, titanium hydroxide, titanium dioxide, and mixtures thereof and most preferably the titanium comprising substance is selected from titanium bromide, titanium fluoride, titanium iodide, titanium chloride, titanyl sulfate and mixtures thereof and the H₃O⁺ ion donor is added before the at least one titanium comprising substance.

According to a preferred embodiment, the calcium carbonate-comprising material is a natural ground calcium carbonate, the at least one H₃O⁺ ion donor is phosphoric acid and/or citric acid, and the at least one titanium comprising substance is selected from the group consisting of a titanium salt, a titanium hydroxide, a titanium oxide, and mixtures thereof, preferably the titanium comprising substance is selected from the group consisting of titanium bromide, titanium fluoride, titanium iodide, titanium chloride, titanyl sulfate, titanium hydroxide, titanium dioxide, and mixtures thereof and most preferably the titanium comprising substance is selected from titanium bromide, titanium fluoride, titanium iodide, titanium chloride, titanyl sulfate and mixtures thereof and the H₃O⁺ ion donor is mixed with the at least one titanium comprising substance in a solution before adding that solution to the calcium carbonate-comprising material.

According to one embodiment of the present invention, in step d) the pH value of the obtained aqueous suspension of surface-reacted calcium carbonate is from 4.5 to 11, preferably from 5.5 to 10, and most preferably from 5.0 to 8.0.

According to one embodiment of the present invention, step d) is carried out at a temperature from 20 to 95° C., preferably from 30 to 85° C., more preferably from 40 to 80° C., even more preferably from 50 to 75° C., and most preferably from 55 to 73° C.

According to one embodiment, the process step d) is carried out for at least 1 min, preferably for at least 5 min, more preferably for at least 10 min, and most preferably for at least 15 min.

According to one embodiment, the at least one H₃O⁺ ion donor is added over a time period of at least 1 min, preferably at least 5 min, and more preferably at least 10 min and afterwards the at least one titanium comprising substance is added for the same time.

Process step d) may be carried out by simply adding, for example, by pouring, discharging, or injecting, the at least one H₃O⁺ ion donor and/or the at least one titanium comprising substance into the calcium carbonate-comprising material. According to one embodiment, process step d) is carried out under mixing conditions. Suitable mixing methods are known to the skilled person. Examples of suitable mixing methods are shaking, mixing, stirring, agitating, ultrasonication, or inducing a turbulent or laminar flow by means such as baffles or lamellae. Suitable mixing equipment is known to the skilled person, and may be selected, for example, from stirrers, such as rotor stator systems, blade stirrers, propeller stirrers, turbine stirrers, or anchor stirrers, static mixers such as pipes including baffles or lamellae. According to an exemplary embodiment of the present invention, a rotor stator stirrer system is used.

According to another exemplary embodiment, in step d) the formed suspension is mixed so as to develop an essentially laminar flow. The skilled person will adapt the mixing conditions such as the mixing speed and temperature according to his process equipment.

Depending on the amount of water that is introduced during step d) by contacting the aforementioned compounds, additional water may be introduced during process step d), for example, in order to control and/or maintain and/or achieve the desired solids content or Brookfield viscosity of the obtained aqueous suspension. According to one embodiment the solids content of the mixture obtained in step d) is from 5 to 80 wt.-%, preferably from 20 to 78 wt.-%, based on the total weight of the mixture. The Brookfield viscosity of the obtained aqueous suspension may be from 10 to 10 000 mPa-s, preferably from 50 to 1 000 mPa-s.

The process of the present invention may be carried out in form of a continuous process or a batch process, preferably in the form of a batch process.

In a further embodiment of the preparation of the surface-reacted natural or precipitated calcium carbonate, the natural or precipitated calcium carbonate is reacted with the one or more H₃O⁺ on donors in the presence of at least one compound selected from the group consisting of silicate, aluminium hydroxide, earth alkali aluminate such as sodium or potassium aluminate, magnesium oxide, or mixtures thereof, Preferably, the at least one silicate is selected from an aluminium silicate, a calcium silicate, or an earth alkali metal silicate. These components can be added to an aqueous suspension comprising the natural or precipitated calcium carbonate before adding the one or more H₃O⁺ ion donors.

Alternatively, the silicate and/or aluminium hydroxide and/or earth alkali aluminate and/or magnesium oxide component(s) can be added to the aqueous suspension of natural or precipitated calcium carbonate while the reaction of natural or precipitated calcium carbonate with the one or more H₃O⁺ ion donors has already started. Further details about the preparation of the surface-reacted natural or precipitated calcium carbonate in the presence of at least one silicate and/or aluminium hydroxide and/or earth alkali aluminate component(s) are disclosed in WO2004083316 A1, the content of this reference herewith being Included in the present application.

### Additional Process Steps

According to one embodiment, the process of the present invention further comprises a step of agitating the aqueous suspension after step d). Preferably, the suspension is agitated for at least 1 min, preferably for at least 5 min, more preferably for at least 10 min, and most preferably for at least 15 min.

According to another embodiment the white UV-absorbing surface-reacted calcium carbonate doped with a titanium species can be kept in suspension and can be optionally further stabilized by a dispersant. Conventional dispersants known to the skilled person can be used. A preferred dispersant is comprised of polyacrylic acids and/or carboxymethylcelluloses However, also other dispersant are possible. The skilled person will choose the dispersant dependent on his equipment and the intended use of the white UV-absorbing surface-reacted calcium carbonate doped with a titanium species.

According to a preferred embodiment, the white UV-absorbing surface-reacted calcium carbonate doped with a titanium species is separated from the aqueous suspension, for example by filtration, and afterwards a dispersant is added to the filter cake, preferably in form of a solution or dispersion.

The skilled person knows how to filter and redispersed the white UV-absorbing surface-reacted calcium carbonate doped with a titanium species and will chose the dispersant and separation method dependent on his equipment and the intended use.

The aqueous suspension obtained after step d) may be further processed, e.g., the white UV-absorbing surface-reacted calcium carbonate doped with a titanium species may be separated from the aqueous suspension and/or subjected to a drying step

According to one embodiment, the process of the present invention further comprises a step e) of separating the white UV-absorbing surface-reacted calcium carbonate doped with a titanium species from the aqueous suspension obtained in step d). Thus, a process for manufacturing a white UV-absorbing surface-reacted calcium carbonate doped with a titanium, species may comprise the following steps:
a) providing a calcium carbonate-comprising material,
b) providing at least one H₃O⁺ ion donor,
c) providing at least one titanium comprising substance, and
d) treating the calcium carbonate-comprising material of step a) with the at least one H₃O⁺ ion donor of step b) in an aqueous medium to form an aqueous suspension of surface-reacted calcium carbonate, and
wherein the at least one titanium comprising substance of step c) is added before/and/or during and/or after step d), and
e) separating the white UV-absorbing surface-reacted calcium carbonate doped with a titanium species from the aqueous suspension obtained from step d).

The white UV-absorbing surface-reacted calcium carbonate doped with a titanium species obtained from step d) may be separated from the aqueous suspension by any conventional means of separation known to the skilled person. According to one embodiment of the present invention, in process step e) the white UV-absorbing surface-reacted calcium carbonate doped with a titanium species is separated mechanically and/or thermally. Examples of mechanical separation processes are filtration, e.g by means of a drum filter or filter press, nanofiltration, or centrifugation. An example for a thermal separation process is a concentrating process by the application of heat, for example, in an evaporator. According to a preferred embodiment, in process step e) the surface-reacted calcium carbonate is separated by solvent evaporation and/or pressure filtration.

After separation, the white UV-absorbing surface-reacted calcium carbonate doped with a titanium species can be dried in order to obtain a dried white LV-absorbing surface-reacted calcium carbonate doped with a titanium species. According to one embodiment, the process of the present invention further comprises a step f) of drying the white UV-absorbing surface-reacted calcium carbonate doped with a titanium species after step d) or after step e), if present, at a temperature in the range from 60 to 600° C., preferably from 80 to 450° C., most preferably from 95 to 400° C., preferably until the moisture content of the white UV-absorbing surface-reacted calcium carbonate doped with a titanium species is less than 1 wt.-%, based on the total weight of the dried white UV-absorbing surface-reacted calcium carbonate doped with a titanium species.

According to one embodiment, the process of the present invention further comprises a step f) of drying the white UV-absorbing surface-reacted calcium carbonate doped with a titanium species from the aqueous suspension obtained in step d) and/or step e). Thus, a process for manufacturing a white UV-absorbing surface-reacted calcium carbonate doped with a titanium species may comprise the following steps:
a) providing a calcium carbonate-comprising material.
b) providing at least one H₃O⁺ ion donor,
c) providing at least one titanium comprising substance, and
d) treating the calcium carbonate-comprising material of step a) with the at least one H₃O⁺ ion donor of step b) in an aqueous medium to form an aqueous suspension of surface-reacted calcium carbonate, and
wherein the at least one titanium comprising substance of step c) is added before/and/or during and/or after step d), and
e) separating the white UV-absorbing surface-reacted calcium carbonate doped with a titanium species from the aqueous suspension obtained from step d) and
f) drying the surface-reacted calcium carbonate.

In general, the drying step f) may take place using any suitable drying equipment and can, for example, include thermal drying and/or drying at reduced pressure using equipment such as an evaporator, a flash drier, an oven, a spray drier and/or drying in a vacuum chamber. The drying step f) can be carried out at reduced pressure, ambient pressure or under increased pressure. For temperatures below 100° C. it may be preferred to carry out the drying step under reduced pressure. The drying step can be performed, for example, for at least 30 seconds, for at least 1 minute, 2 minutes, 5 minutes, 10 minutes, 30 minutes, 1 hour, 2 hours, 12 hours or 1 day. The skilled person can choose the drying time dependent on the equipment, the water content and the intended use.

According to one preferred embodiment, the separation is carried out by a thermal method. This may allow to dry the white UV-absorbing surface-reacted calcium carbonate doped with a titanium species subsequently without changing the equipment.

According to one embodiment, in process step f) the surface-reacted calcium carbonate is dried until the moisture content of the white UV-absorbing surface-reacted calcium carbonate doped with a titanium species is less than or equal to 1.0 wt.-%, based on the total weight of the dried white UV-absorbing surface-reacted calcium carbonate doped with a titanium species, preferably less than or equal to 0.5 wt.-%, and more preferably less than or equal to 0.2 wt.-%.

According to another embodiment, the process of the present invention further comprises a step g) of treating the surface of the white UV-absorbing surface-reacted calcium carbonate doped with a titanium species from the aqueous suspension obtained in step d) and/or step e) and/or step f).

Thus, a process for manufacturing a white UV-absorbing surface-reacted calcium carbonate doped with a titanium species may comprise the following steps:
a) providing a calcium carbonate-comprising material,
b) providing at least one H₃O⁺ ion donor,
c) providing at least one titanium comprising substance, and
d) treating the calcium carbonate-comprising material of step a) with the at least one H₃O⁺ ion donor of step b) in an aqueous medium to form an aqueous suspension of surface-reacted calcium carbonate,
wherein the at least one titanium comprising substance of step c) is added before/and/or during and/or after step d), arid
e) separating the white UV-absorbing surface-reacted calcium carbonate doped with a titanium species from the aqueous suspension obtained from step d) and
f) drying the surface-reacted calcium carbonate and
g) treating the surface of the obtained white UV-absorbing surface-reacted calcium carbonate doped with a titanium species.

In general, the treatment step g) may take place using any suitable treatment agent, for example hydrophobic agents such as fatty acids. Such hydrophobic agents like stearic acid and palmitic acid are known to the skilled person and are commercially available. The surface treatment of the white UV-absorbing surface-reacted calcium carbonate doped with a titanium species may affect the rheological properties of that material.

The inventors surprisingly found out that by the described inventive process it is possible to prepare surface-reacted calcium carbonate particles that are doped with a titanium species. The process for producing these particles is an easy and quick process and the obtained product is affordable and especially easy to handle. The process can be performed in standard equipment without significant burden for humans and environment. Such a process and product is advantageous since the end consumer has not to handle particles that comprise titanium dioxide in form of powders comprising submicrometer or nanometer size titanium dioxide particles. Therefore, dusting can be reduced or eliminated, which may occur when both compounds, surface-reacted calcium carbonate and a titanium containing material (e.g. titanium dioxide), are mixed in form of dry products, which may cause health issues, especially when inhaled. Furthermore, the particles separation during transport can be reduced or eliminated, which may occur when both compounds, surface-reacted calcium carbonate and titanium dioxide, are mixed in form of dry products.

The White UV-Absorbing Surface-Reacted Calcium Carbonate Doped with a Titanium Species

According to a further aspect of the present invention, a white UV-absorbing surface-reacted calcium carbonate doped with a titanium species is provided, comprising calcite and hydroxyapatite and having a specific surface area of from 15 m²/g to 200 m²/g, measured using nitrogen and the BET method according to ISO 9277:2010,
wherein the weight ratio of calcite to hydroxyapatite is from 99:1 to 1:99 based on the dry weight of the calcite and the dry weight of the hydroxyapatite, and
wherein the titanium species is presenting an amount from 0.01 to 20 wt-% of titanium element, based on the total dry weight of the surface-reacted calcium carbonate.

The white UV-absorbing surface-reacted calcium carbonate doped with a titanium species is obtainable by the process of the present invention. Thus, the white UV-absorbing surface-reacted calcium carbonate doped with a titanium species may be obtained by a process comprising the steps of:
a) providing a calcium carbonate-comprising material,
b) providing at least one H₃O⁺ ion donor,
c) providing at least one titanium comprising substance, and
d) treating the calcium carbonate-comprising material of step a) with the at least one H₃O⁺ ion donor of step b) in an aqueous medium to form an aqueous suspension of surface-reacted calcium carbonate, and
wherein the at least one titanium comprising substance of step c) is added before and/or during and/or after step d).

The white UV-absorbing surface-reacted calcium carbonate doped with a titanium species may be present in a suspension or slurry or may be present as dry white UV-absorbing surface-reacted calcium carbonate doped with a titanium. species.

According to one embodiment the white UV-absorbing surface-reacted calcium carbonate doped with a titanium species has a specific surface area of from 25 m²/a to 180 m²g, more preferably from 30 m²/g to 160 m²/g, even more preferably from 45 m²/g to 150 m²/g, most preferably from 50 m²g to 140 m²/g, measured using nitrogen and the BET method according to ISO 9277:2010. For example, the white UV-absorbing surface-reacted calcium carbonate doped with a titanium species may have a specific surface area of from 55 m²/g to 100 m²/g, measured using nitrogen and the BET method. The BET specific surface area in the meaning of the present invention is defined as the surface area of the particles divided by the mass of the particles. As used therein the specific surface area is measured by adsorption using the BET isotherm (ISO 9277:2010) and is specified in m²/g.

Additionally or alternatively, the white UV-absorbing surface-reacted calcium carbonate doped with a titanium species has a volume determined median particle size d₅₀(vol) from 1 to 100 μm, preferably from 2 to 60 μm, more preferably from 3 to 40 μm, even more preferably from 4 to 30 μm, and most preferably from 5 to 15 μm.

Additionally or alternatively, the white UV-absorbing surface-reacted calcium carbonate doped with a titanium species has a volume determined top cut particle size d₉₈(vol) from 2 to 150 μm, preferably from 4 to 100 μm, more preferably from 6 to 80 μm, even more preferably from 6 to 60 μm, and most preferably from 10 to 30 μm.

The value dₓ represents the diameter relative to which x % of the particles have diameters less than dₓ. This means that the d₉₈ value is the particle size at which 98% of all particles are smaller. The d₉₈ value is also designated as “top cut”. The d, values may be given in volume or weight percent. The d₅₀ (wt) value is thus the weight median particle size, i.e. 50 wt.-% of all grains are smaller than this particle size, and the d₅₀ (vol) value is the volume median particle size, i.e. 50 vol.-% of all grains are smaller than this particle size.

Volume median grain diameter d₅₀ was evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

The processes and instruments are known to the skilled person and are commonly used to determine grain size of fillers and pigments.

The white UV-absorbing surface-reacted calcium carbonate doped with a titanium species may have an intra-particle intruded specific pore volume in the range from 0.1 to 2.3 cm³/g, preferably from 0.2 to 2.0 cm³/g, more preferably from 0.4 to 1.8 cm³/g and most preferably from 0.6 to 1.6 cm³/g, calculated from mercury porosimetry measurement.

The intra-particle pore size of the white UV-absorbing surface-reacted calcium carbonate doped with a titanium species preferably is in a range of from 0.004 to 1.6 μm, more preferably in a range of between 0.005 to 1.3 μm, especially preferably from 0.006 to 1.15 μm and most preferably of 0.007 to 1.0 μm, e.g. 0.1 to 0.6 μm determined by mercury porosimetry measurement.

The specific pore volume is measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm (˜nm). The equilibration time used at each pressure step is 20 seconds. The sample material is sealed in a 5 cm³ chamber powder penetrometer for analysis. The data are corrected for mercury compression. penetrometer expansion and sample material compression using the software Pore-Comp (Gane, P. A. C., Kettle, J. P. Matthews, G. P. and Ridgway, C. J, “Void Space Structure of Compressible Polymer Spheres and Consolidated Calcium Carbonate Paper-Coating Formulations”, industrial and Engineering Chemistry Research, 35(5), 1996, p1753⁻1764.)

The total pore volume seen in the cumulative intrusion data can be separated into two regions with the intrusion data from 214 μm down to about 1⁻4 μm showing the coarse packing of the sample between any agglomerate structures contributing strongly. Below these diameters lies the fine interparticle packing of the particles themselves. If they also have intraparticle pores, then this region appears bi-modal, and by taking the specific pore volume intruded by mercury into pores finer than the modal turning point, i.e. finer than the bi-modal point of inflection, the specific intraparticle pore volume is defined. The sum of these three regions gives the total overall pore volume of the powder, but depends strongly on the original sample compaction/settling of the powder at the coarse pore end of the distribution.

By taking the first derivative of the cumulative intrusion curve the pore size distributions based on equivalent Laplace diameter, inevitably including pore-shielding, are revealed. The differential curves clearly show the coarse agglomerate pore structure region, the interparticle pore region and the intraparticle pore region, if present. Knowing the intraparticle pore diameter range it is possible to subtract the remainder interparticle and interagglomerate pore volume from the total pore volume to deliver the desired pore volume of the internal pores alone in terms of the pore volume per unit mass (specific pore volume). The same principle of subtraction, of course, applies for isolating any of the other pore size regions of interest.

According to one embodiment the white UV-absorbing surface-reacted calcium carbonate doped with a titanium species has
(i) a specific surface area of from 25 m²/g to 180 m²/g, more preferably from 30 m²/g to 160 m²/g, even more preferably from 45 m²/g to 150 m²/g, most preferably from 50 m²/g to 140 m²/g, measured using nitrogen and the BET method according to ISO 9277:2010 and/or
(ii) a volume determined median particle size d₅₀(vol) from 1 to 100 μm, preferably from 2 to 60 μm, more preferably from 3 to 40 μm, even more preferably from 4 to 30 μm, and most preferably from 5 to 15 μm, and/or
(iii) a volume determined top cut particle size d₉F(vol) from 2 to 150 μm, preferably from 4 to 100 μm, more preferably from 6 to 80 μm, even more preferably from 8 to 60 μm, and most preferably from 10 to 30 μm and/or
(iv) an intra-particle intruded specific pore volume in the range from 0.1 to 2.3 cm³/g, preferably from 0.2 to 2.0 cm³/g, more preferably from 0.4 to 1.8 cm³/g, and most preferably from 0.6 to 1.6 cm³/g, calculated from mercury porosimetry measurement.

According to a preferred embodiment the white UV-absorbing surface-reacted calcium carbonate doped with a titanium species has a specific surface area of from 50 m²/g to 140 m²/g, measured using nitrogen and the BET method according to ISO 9277:2010 and
(ii) a volume determined median particle size d₅₀(vol) from 1 to 100 μm, preferably from 2 to 60 μm, more preferably from 3 to 40 μm, even more preferably from 4 to 30 μm, and most preferably from 5 to 15 μm, and/or
(iii) a volume determined top cut particle size d₉₈(vol) from 2 to 150 μm, preferably from 4 to 100 μm, more preferably from. 6 to 80 μm, even more preferably from 8 to 60 μm, and most preferably from 10 to 30 μm and/or
(iv) an intra-particle intruded specific pore volume in the range from 0.1 to 2.3 cm³/g, preferably from 0.2 to 2.0 cm³/g, more preferably from 0.4 to 1.8 cm³/g, and most preferably from 0.6 to 1.6 cm³/g, calculated from mercury porosimetry measurement.

The white UV-absorbing surface-reacted calcium carbonate doped with a titanium species comprises calcite and hydroxyapatite.

“Hydroxyapatite” in the meaning of the present invention, also called hydroxylapatite (HA), is a naturally occurring mineral form of calcium apatite with the formula Cas(PO₄)₃(OH). The hydroxyapatite may be further substituted with a carbonate ion and/or a halide ion such as fluoride, bromide, iodide, chloride ion or mixtures thereof instead of the hydroxy group.

“Calcite” in the meaning of the present invention is the most common crystal polymorph of calcium carbonate and is considered to be the most stable crystal form of calcium carbonate.

According to the present invention, the weight ratio of calcite to hydroxyapatite is from 99_1 to 1:99 based on the dry weight of the calcite and the dry weight of the hydroxyapatite. According to a preferred embodiment of the present invention, the weight ratio of calcite to hydroxyapatite is from 80:20 to 20:80 based on the dry weight of the calcite and the dry weight of the hydroxyapatite, more preferably from 70:30 to 30:70 and most preferably from 60:40 to 40:60.

According to another preferred embodiment the white UV-absorbing surface-reacted calcium carbonate doped with a titanium species has a specific surface area of from 50 m²/g to 140 m²/g, measured using nitrogen and the BET method according to ISO 9277:2010 and the weight ratio of calcite to hydroxyapatite is from 60:40 to 40:60 based on the dry weight of the calcite and the dry weight of the hydroxyapatite.

In addition to calcite and hydroxyapatite, the white UV-absorbing surface-reacted calcium carbonate doped with a titanium species may comprise further crystal structures such as, for example, aragonite and/or vaterite. According to a preferred embodiment of the present invention the white UV-absorbing surface-reacted calcium carbonate doped with a titanium species does only comprise calcite and hydroxyapatite as calcium carbonate crystal structures but no further calcium carbonate crystal structures.

The white UV-absorbing surface-reacted calcium carbonate is doped with a titanium species. “Doped” with a titanium species in the meaning of the present invention refers to the incorporation or introduction of a titanium species in the structure of the calcium carbonate and/or hydroxyapatite. The doping of the surface-reacted calcium carbonate with a titanium species may be present only in an outer layer of the surface-reacted calcium carbonate or may be present within the whole surface-reacted calcium carbonate. The doping may be present even or uneven in the surface-reacted calcium carbonate. According to a preferred embodiment of the present invention the doping with the titanium species is present even within the whole surface-reacted calcium carbonate. “Doping” in the meaning of the present invention is different to a mere mixture of surface-reacted calcium carbonate with a titanium species or to a coating with the titanium species. The skilled person knows how to measure whether a structure is doped or merely mixed with a titanium species, for example by SEM measurements. For example, by SEM measurement, the skilled person knows how to distinguish between individual particles and attached particles.

The titanium species in the meaning of the present invention refers to titanium in oxidation numbers different to zero. According to one embodiment of the present invention, the titanium species in the meaning of the present invention refers to Ti²⁺, Ti³⁺ and/or Ti⁴⁺, preferably Ti³⁺ and/or Ti⁴⁺, and most preferably Ti⁴⁺.

The titanium species is present in an amount from 0.01 to 20 wt-.% of titanium element, based on the total dry weight of the surface-reacted calcium carbonate. According to a preferred embodiment of the present invention the titanium species is present in an amount from 0 05 to 15 wt-% of titanium element, based on the total dry weight of the surface-reacted calcium carbonate, more preferably from 0.1 to 10 wt.-%, and most preferably from 0.5 to 5 wt.-%,

According to another preferred embodiment the white UV-absorbing surface-reacted calcium carbonate doped with a titanium species has a specific surface area of from. 50 m²/g to 140 m²/g, measured using nitrogen and the BET method according to ISO 9277:2010 and the titanium species is present in an amount from 0.5 to 5 wt-% of titanium element, based on the total dry weight of the surface-reacted calcium carbonate.

According to another preferred embodiment the white UV-absorbing surface-reacted calcium carbonate doped with a titanium species has a specific surface area of from 50 m²/g to 140 m²/g, measured using nitrogen and the BET method according to ISO 9277:2010 and the weight ratio of calcite to hydroxyapatite is from 60:40 to 40:60 based on the dry weight of the calcite and the dry weight of the hydroxyapatite and the titanium species is present in an amount from 0.5 to 5 wt.-% of titanium element, based on the total dry weight of the surface-reacted calcium carbonate.

The white UV-absorbing surface-reacted calcium carbonate that is doped with a titanium species obtainable by a process of the present invention can be provided in form of a suspension of white UV-absorbing surface-reacted calcium carbonate doped with a titanium species, as a separated white UV-absorbing surface-reacted calcium carbonate doped with a titanium species or as a dried white UV-absorbing surface-reacted calcium carbonate doped with a titanium species. According to a preferred embodiment the white UV-absorbing surface-reacted calcium carbonate doped with a titanium species is a dried white UV-absorbing surface-reacted calcium carbonate doped with a titanium species.

In case the white UV-absorbing surface-reacted calcium carbonate doped with a titanium species has been dried, the moisture content of the dried white UV-absorbing surface-reacted calcium carbonate doped with a titanium species is less than or equal to 1.0 wt.-%, based on the total weight of the dried white UV-absorbing surface-reacted calcium carbonate doped with a titanium species, preferably less than or equal to 0.5 wt.-%, and more preferably less than or equal to 0.2 wt.-%.

According to another embodiment, the moisture content of the dried white UV-absorbing surface-reacted calcium carbonate doped with a titanium species is between 0.01 and 0.15 wt-%, preferably between 0.02 and 0.10 wt.-%, and more preferably between 0.03 and 0.07 wt.-%, based on the total weight of the dried white UV-absorbing surface-reacted calcium carbonate doped with a titanium species.

The inventive white UV-absorbing surface-reacted calcium carbonate doped with a titanium species may also be provided and/or used in form of a composition. According to one aspect of the present invention, a composition is provided comprising a white UV-absorbing surface-reacted calcium carbonate doped with a titanium species according to present invention. Said composition may further comprise an additional surface-reacted calcium carbonate, wherein the additional surface-reacted calcium carbonate is a reaction product of natural ground calcium carbonate or precipitated calcium carbonate with at least one H₃O⁺ ion donor. Alternatively, or additionally other filler materials such as natural ground calcium carbonate, precipitated calcium carbonate, and mixtures thereof may be present. The composition may comprise the white UV-absorbing surface-reacted calcium carbonate doped with a titanium species according to present invention in an amount of at least 20 wt.-%, based on the total weight of the composition, preferably at least 40 wt.-%, more preferably at least 60 wt-%, and most preferably at least 80 wt-%.

The inventors surprisingly found that by the inventive process a surface-reacted calcium carbonate is formed which provides additional functionalities due to the doping of the surface-reacted calcium carbonate with a titanium comprising species.

For example, the inventors of the present invention found that the surface-reacted calcium carbonate doped with a titanium species absorbs at least some of the UV radiation in the range from 280 to 400 nm. Therefore, the inventive surface-reacted calcium carbonate can be used for sun protection of plants and parts thereof or for chemical and physical sun protection in a cosmetic formulation.

Furthermore, the inventors of the present invention found that the surface-reacted calcium carbonate doped with a titanium species is white and, therefore, may be used in suspensions, dispersions or slurries of minerals, fillers or pigments, which are typically employed in polymer applications, paper coating applications, paper making, especially in décor paper making, paints, coatings, sealants, adhesives, feed, pharmaceuticals, concrete, cement, cosmetics, water treatment, engineered wood applications, plasterboard applications, packaging applications, catalysis, gas treatment applications and/or agricultural applications and provides a white appearance without adding further pigments.

Furthermore, the inventors surprisingly found that white UV-absorbing surface-reacted calcium carbonate doped with a titanium species has a defined ratio of calcite to hydroxyapatite. Additionally, it has been found that the titanium species cannot be separated from the surface-reacted calcium carbonate by mere washing or in liquid compositions due to the doping.

Additionally, the inventors surprisingly found that white UV-absorbing surface-reacted calcium carbonate doped with a titanium species has a high surface area which is a fundamental prerequisite for several applications.

Since the white UV-absorbing surface-reacted calcium carbonate is doped with a titanium species it has not to be labelled in the ingredient list with titanium dioxide particles in the submicron and/or nanometer size range and, therefore, should have a higher acceptance from the end consumer.

Use of the White UV-Absorbing Surface-Reacted Calcium Carbonate Doped with a Titanium Species

The white UV-absorbing surface-reacted calcium carbonate doped with a titanium species may be used for various applications.

According to one embodiment, the white UV-absorbing surface-reacted calcium carbonate doped with a titanium species according to the present invention or a composition comprising the same is used in polymer applications, paper coating applications, paper making, especially in décor paper making, paints, coatings, sealants, adhesives, feed, pharmaceuticals, concrete, cement, cosmetics, water treatment, engineered wood applications, plasterboard applications, packaging applications, catalysis, gas treatment applications and/or agricultural applications. Engineered wood applications may comprise the use in engineered wood products such as wood composites materials, preferably medium density fibre boards or chipboards.

According to another embodiment of the present invention the white UV-absorbing surface-reacted calcium carbonate doped with a titanium species according to the present invention or a composition comprising the same is used for sun protection of plants and parts thereof or for chemical and physical sun protection in a cosmetic formulation.

The inventors surprisingly found out that such a white UV-absorbing surface-reacted calcium carbonate doped with a titanium species invention or a composition comprising the same provides sufficient sun protection to living cells and especially to human skin.

According to one embodiment of the present invention, the cosmetic formulation is a sunscreen product, facial makeup product, hair care product, hand care product, skin care product, body care product and mixtures thereof.

The inventive surface-reacted calcium carbonate may be incorporated into an article in order to provide an article with enhanced white colour and/or enhanced UV-absorbing properties. According to a further aspect of the present invention, an article is provided comprising a surface-reacted calcium carbonate obtainable by a process according to the present invention or a composition comprising the same, wherein the article is selected from paper products, engineered wood products, plasterboard products, polymer products, hygiene products, medical products, healthcare products, filter products, woven materials, nonwoven materials, geotextile products, agriculture products, horticulture products, clothing, footwear products, baggage products, household products, industrial products, packaging products, building products, and construction products.

The inventors have especially found that the inventive white UV-absorbing surface-reacted calcium carbonate doped with a titanium species can be used in paper applications, especially in paper making, for example in décor paper making. It has been found that a part of the titanium dioxide in décor paper, which is quite expensive can be replaced by the inventive white UV-absorbing surface-reacted calcium carbonate doped with a titanium species and still the décor paper has improved optical properties like improved opacity, improved brightness Rγ and an improved whiteness L*.

### FIGURES

FIG. 1: UV-Vis spectroscopy of GCC and samples 1 to 8 measured at 340 nm at room temperature

FIG. 2 shows a SEM image of sample 4

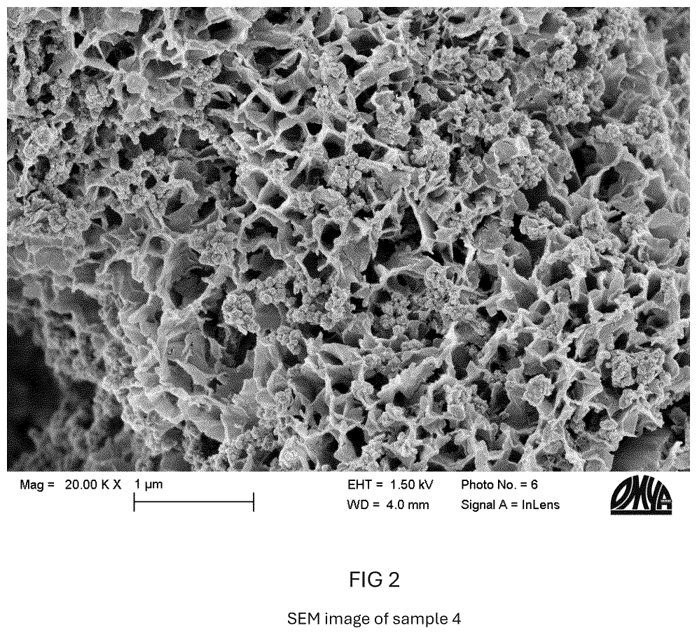

The scope and interest of the invention will be better understood based on the following examples which are intended to illustrate certain embodiments of the present invention and are non-limitative.

### Examples Section

### 1. Measurement Methods

The following measurement methods were used to evaluate the parameters given in the examples and claims.

### BET Specific Surface Area (SSA) of a Material

The BET specific surface area was measured via the BET process according to ISO 9277:2010 using nitrogen and a ASAP 2460 instrument (Micromeritics GmbH, Germany), following conditioning of the sample by heating at 100° C. for a period of 30 minutes. Prior to such measurements, the sample was filtered, rinsed and dried at 110° C. in an oven for at least 12 hours.

Particle Size Distribution (Volume % Particles with a Diameter <X), d₅₀ Value (Volume Median Grain Diameter) and Des Value of a Particulate Material:

Volume median grain diameter d₅₀ was evaluated using a Malvern Mastersizer 3000 Laser Diffraction System. The d₅₀ or d₉₈ value, measured using a Malvern Mastersizer 3000 Laser Diffraction System, indicates a diameter value such that 50% or 98% by volume, respectively, of the particles have a diameter of less than this value The raw data obtained by the measurement are analysed using the Mie theory, with a particle refractive index of 1.57 and an absorption index of 0.005.

The weight median grain diameter is determined by the sedimentation method, which is an analysis of sedimentation behaviour in a gravimetric field. The measurement is made with a Sedigraph™, 5120, Micromeritics Instrument Corporation. The method and the instrument are known to the skilled person and are commonly used to determine grain size of fillers and pigments. The measurement is carried out in an aqueous solution of 0.1 wt % Na₄P₂O₇. The samples were dispersed using a high speed stirrer and super sonicated.

The processes and instruments are known to the skilled person and are commonly used to determine grain size of fillers and pigments.

Porosity Measurements

Portions of the white UV-absorbing surface-reacted calcium carbonate doped with a titanium species or of the titanium dioxide were characterized by mercury porosimetry for porosity, intruded total specific void volume, and pore size distribution using a Micromeritics Autopore V 9620 mercury porosimeter. The maximum. applied pressure of mercury was 414 MPa, equivalent to a Laplace throat diameter of 0.004 μm. The equilibration time used at each pressure step is 20 s and the sample material is seal in a 3 cm³ chamber powder penetrometer. The data were corrected using Pore-Comp (P. A. C. Gane et al. “Void Space Structure of Compressible Polymer Spheres and Consolidated Calcium Carbonate Paper-Coating Formulations” (Industrial and Engineering Chemistry Research 1996, 35 (5), 1753⁻1764) for mercury compression and penetrometer effects, and also for elastic sample compression. By taking the first derivative of the cumulative intrusion curves the pore size distributions based on equivalent Laplace diameter, inevitably including pore-shielding, was revealed. Volume defined median pore diameter was calculated from the mercury intrusion curve, and volume defined pore size polydispersity as full width at half maximum (FWHM) is calculated from the pore size distribution curve.

### X-Ray Diffraction (XRD)

XRD experiments are performed on the samples using rotatable PMMA holder rings. Samples are analyzed with a Bruker D8 Advance powder diffractometer obeying Bragg's law. This diffractometer comprises a 2.2 kW X-ray tube, a sample holder, a θ-θ-goniometer, and a VANTEC-1 detector. Nickel-filtered Cu-Kα radiation is employed in all experiments. The profiles are chart recorded automatically using a scan speed of 0.7° per min in 2 θ (XRD GV_7600). The resulting powder diffraction patterns are classified by mineral content using the DIFFRACsuite software packages EVA and SEARCH, based on reference patterns of the ICDD PDF-2 database (XRD L.TM_7603).

Quantitative analysis of diffraction data refers to the determination of amounts of different phases in a multi-phase sample and has been performed using the DIFFRACsuite software package TOPAS. In detail, quantitative analysis allows to determine structural characteristics and phase proportions with quantifiable numerical precision from the experimental data itself. This involves modelling the full diffraction pattern using the Rietveld approach such that the calculated pattern(s) duplicates the experimental one.

### Reflectance Measurements

Reflectance analysis was carried out with a double beam PerkinElmer Lambda 950 IJV/Vis/NIR spectrophotometer equipped with a 150 mm integrating sphere with PMT and InGaAs detectors,

The prepared dry compositions were measured by reflectance spectroscopy. The analysis was performed with the dry composition loaded into a sealed aluminum cup for powder samples, which was placed flush with the reflectance port of the integrating sphere. The spectrophotometer was scanned in the range 280 nm-800 nm in steps of 2 nm. A Spectralon white standard was used as 100% baseline. To get a proxy for the absorption spectrum of the dry composition, the measured reflectance spectrum was converted using the Kubelka-Munk equation K-M=K/S=(1-R)²/2R, where R is the reflectance and K and S are the absorption and scattering coefficient, respectively.

### (XRF) Measurements

11.5 g dry sample was pressed to a tablet, using a press at 400 kN. The elemental composition of the sample was measured by sequential, wavelength dispersive X-ray fluorescence (using an ARL™ PERFORM′X X-ray fluorescence spectrometer, Thermo Fisher Scientific, Inc., USA). The quantification was made by means of an external calibration which was especially prepared for calcium carbonate.

### Brightness Rγ and Paper Opacity

Brightness Rγ and décor paper opacity were measured on the obtained décor papers as prepared below over a white and black underlay. The décor papers were stored for 24 h at 23±1° C. and 50±2% relative humidity and afterwards measured at the same temperature and humidity. The measuring was performed with a Elrepho-Spectrophotometer 3300 ERIC (Lorentzen & Wettre) according to ISO 2471:2008⁻12. A measuring orifice XLAV (diameter 34 mm), a D65/10° light source and a R457 filter has been used.

The opacity is calculated from the quotient of the mean of the reflection Rγ of the black background and the mean value of the reflection factor Rγ of the white background and is expressed in %.

### CIELAB Coordinates

The color values (CIELAB L*, a*, b* coordinates) were measured on the obtained décor papers as prepared below over a white and black underlay. The décor papers were stored for 24 h at 23±1° C. and 50±2% relative humidity and afterwards measured at the same temperature and humidity. The measuring was performed with a Elrepho-Spectrophotometer 3300 ERIC (Lorentzen & Wettre) according to iSO 5631⁻2:2015⁻11 (light D65). A measuring orifice XLAV (diameter 34 mm) has been used.

### 2. Material and Equipment

calcium carbonate-comprising material:
GCCI: Ground marble calcium carbonate from Carrera, Italy. The ground calcium carbonate had a medium weight based particle size distribution d₅₀ of 7.9 μm, as determined by sedimentation.
GCCII: Ground marble calcium carbonate obtained from Hustadmarmor, Norway The ground calcium carbonate had a medium weight based particle size distribution d₅₀ 1.7 μm, as determined by sedimentation.

H₃O⁺ ion donor:
Phosphoric acid (H₃PO₄) available from VWR Chemicals (ortho phosphoric acid 85%)

Titanium comprising substance:
Titanium oxysulfate I TiOSO4×2O available from Sigma-Aldrich under the number 14023-1

Titanium dioxide
a non-porous titanium dioxide with a specific surface area (SSA) of 6.8 m²/g and a medium weight based particle size distribution d₅₀ 1.7 μm, as determined by sedimentation

Wet Strength Agent:
solution of an adipinic acid diethylene triamin epichlorhydrin copolymer (Giluton® XP 14, BK Giulini GmbH)

### 3. Sample Preparation

White UV-Absorbing Surface-Reacted Calcium Carbonate Doped with a Titanium Species I

165 g of GCCI is added into 940 mL of water. The slurry is mixed at 75° C., for 15 minutes. The resulting mixture is called GCCI slurry.

A H₃PO₄ solution is prepared by using 58 g of phosphoric acid in 107 mL. of distilled water (Solution A). Solution A is added to the GCCI slurry with a flowrate of 15 g/min, with a full addition time of ca. 10 minutes.

For a 2.5 wt % of titanium, 13.6 g of the titanium comprising substance is added to 1.1 L of water. The salt addition is to be performed in portions and under stirring.

Afterwards, the solvent is eliminated by solvent evaporation (in an oven at 100° C. over night) or pressure filtration (vacuum filtration—water pump vacuum at room temperature).

Different inventive and comparative experiments are performed as listed below. Each sample was dried at 125° C. and 300° C.

| | Addition of H₃O⁺ ion donor and | |
|---|---|---|
| Sample name | Titanium comprising substance | Solvent elimination |
| Sample 1 | Ti salt in the H₃PO₄ solution | Solvent evaporation |
| Sample 2 | Ti salt before the H₃PO₄ solution | |
| Sample 3 | Ti salt after the H₃PO₄ solution | |
| Sample 4 | Ti salt in the H₃PO₄ solution | Pressure filtration |
| Sample 5 | No H₃PO₄, only Ti salt | Solvent evaporation |
| Sample 6 | Only H₃PO₄ | Pressure filtration |
| Sample 7 | Sample 6 + Ti salt | Pressure filtration |

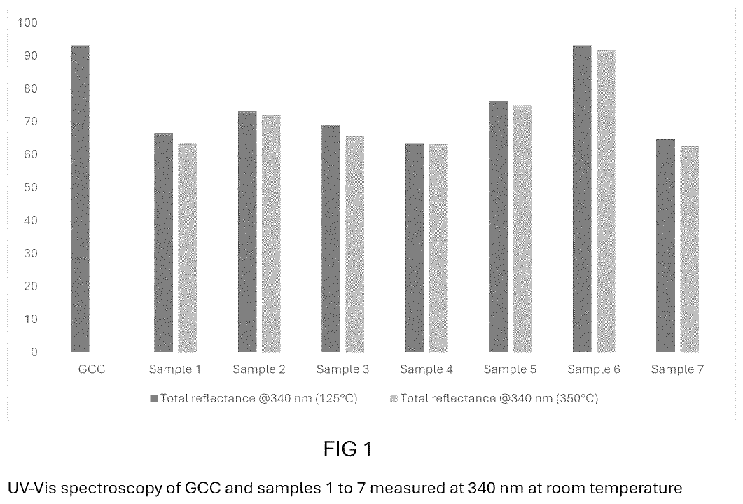

The obtained samples have been analyzed using UV-Vis spectroscopy. The total reflectance of the samples at 340 nm was measured at room temperature as shown in FIG. 1.

White UV-Absorbing Surface-Reacted Calcium Carbonate Doped with a Titanium Species II GCCII Slurry Preparation

7 liters of an aqueous suspension of ground calcium carbonate is prepared in a mixing vessel by adjusting the solids content of GCCII such that a solids content of 14 wt.-%, based on the total weight of the aqueous suspension, is obtained. The slurry is mixed at 70° C., for 15 minutes.

### Sample 8

Whilst mixing the GCCII slurry, 1391 g of phosphoric acid at 23 wt. % is added over 60 minutes. Throughout the whole addition the temperature of the suspension is maintained at 70° C. 1⁻1° C. After the addition of the phosphoric acid, the suspension is stirred for additional 5 minutes before removing it from the vessel and allowing it to cool.

### Sample 9

Separately, a titanium comprising substance solution is prepared in phosphoric acid via the slow addition of the titanium comprising substance dissolved in deionized water such that the final concentration is 40.5 wt % H₃PO₄ and 6.9 wt. % TiOSO₄×H₂O. This solution is subsequently diluted with more distilled water such that H₃PO₄ has a concentration of 23 wt. %.

Whilst mixing the GCCII slurry, 1075 g of the titanium comprising substance solution is added over 60 minutes. Throughout the whole addition, the temperature of the resulting mixture is maintained at 70° C. +/−1” ° C. Then, the resulting mixture is stirred for additional 5 minutes before removing it from the vessel and allowing it to cool.

### Sample 10

Separately, a titanium comprising substance solution is prepared in phosphoric acid via the slow addition of the titanium comprising substance dissolved in deionized water such that the final concentrations is 40.5 wt. % H₃PO₄ and 6.9 wt,% TiOS₄×H₂O. This solution is subsequently diluted with more distilled water such that H₃PO₄ has a concentration of 23 wt. %.

Whilst mixing the GCCII slurry, 2093 g of the titanium comprising substance solution is added over 60 minutes. Throughout the whole addition, the temperature of the resulting mixture is maintained at 70° C. +− 1° C. Then, the resulting mixture is stirred for additional 5 minutes before removing it from the vessel and allowing it to cool.

Afterwards, the solvent in the resulting mixture is eliminated by pressure filtration in a water pump vacuum over a Buchner funnel. Each sample was dried at 125° C. The obtained samples have been analyzed using UV-Vis spectroscopy. The total reflectance of the samples at 340 nm was measured at room temperature

From FIG. 1 it can be seen that comparative sample 6 has a total reflectance similar to the total reflectance of the raw GCCI. When comparing sample 6 with samples 1 to 4, it can be seen that these samples have much lower total reflectance values between 62 and 77%. Therefore, it has been shown that the addition of the at least one titanium comprising substance is possible before and/or during and/or after step d) (samples 1 to 3). Furthermore, the solvent elimination has no influence on the obtained white UV-absorbing surface-reacted calcium carbonate doped with a titanium species as can be seen from samples 1 and 3.

It can be seen that comparative sample 8 has a total reflectance of 93.79%. When comparing sample 8 with samples 9 and 10, it can be seen that these samples have much lower total reflectance values between 86 and 90%. Therefore, by the inventive process a white UV-absorbing surface—reacted calcium carbonate doped with a titanium species can be prepared.

| | Sample 8 | Sample 9 | Sample 10 |
|---|---|---|---|
| Reflectance at 340 nm in % | 93.79 | 89.39 | 86.53 |

The samples 1 to 10 were analyzed by XRD and XRF and additionally, the surface area was evaluated using BET technique.

| Sample | XRD (%) | | XRF (%) | | SSA | |
|---|---|---|---|---|---|---|
| name | calcite | hydroxyapatite | S | Ti | (m²/g) | Invention |
| Sample 1 | 42 | 55 | 3.4 | 2.5 | 72 | Yes |
| Sample 2 | 42 | 54 | 3.3 | 2.6 | 76 | Yes |
| Sample 3 | 47 | 48 | 3.6 | 2.5 | 58 | Yes |
| Sample 4 | 45 | 54 | 1.7 | 2.6 | 70 | Yes |
| Sample 5 | 94 | 0 | 2.8 | 2.6 | 9 | No |
| Sample 6 | 47 | 52 | 0.04 | 0.01 | 60 | No |
| Sample 7 | 45 | 54 | 0.72 | 2.8 | 12 | No |
| Sample 8 | 49 | 41 | 0.02 | <0.01 | 41.3 | No |
| Sample 9 | 62 | 38 | 0.43 | 0.65 | 36.3 | Yes |
| Sample 10 | 37 | 63 | 0.87 | 1.03 | 56.8 | Yes |

From samples 1 to 4 and 9 and 10 it can be seen that by the inventive process of the present invention it is possible to prepare white UV-absorbing surface-reacted calcium carbonate doped with a titanium species.

From sample 5 it can be seen that without the addition of a H₃O⁺ ion donor no hydroxyapatite is formed. Furthermore, the BET value is below 15 m²/g.

From samples 6 and 8 it can be seen that without the addition of a titanium, comprising substance no titanium is present.

From sample 7 it can be seen that by merely mixing of the surface-reacted calcium carbonate and the titanium comprising substance the BET is 12 m²/g and, therefore, below the claimed value of the white UV-absorbing surface-reacted calcium carbonate doped with a titanium species Without being bound to any theory, the inventors believe that by merely mixing the surface-reacted calcium carbonate and the titanium comprising substance, the pores on the surface are clogged.

Furthermore, from sample 4 a SEM picture has been made. It can be seen that due to the treatment of the calcium carbonate-comprising material with the at least one H₃O⁺ ion donor, and at least one titanium comprising substance a white UV-absorbing surface-reacted calcium carbonate doped with a titanium species is obtained, that has a unique structure with a high surface area wherein the pores of the obtained product are not clogged.

Therefore, it has been shown by the examples that by the inventive process of the preset invention it is possible to prepare a white UV-absorbing surface-reacted calcium carbonate doped with a titanium species, comprising calcite and hydroxyapatite and having a specific surface area of from m/g to 200 m²Ig, measured using nitrogen and the BET method according to ISO 9277⁻2010, wherein the weight ratio of calcite to hydroxyapatite is from 99:1 to 1:99 based on the dry weight of the calcite and the dry weight of the hydroxyapatite, and wherein the titanium species is present in an amount from 0.01 to 20 wt.-% of titanium element, based on the total dry weight of the surface-reacted calcium, carbonate.

Additionally, the d₅₀ and the intra-particle intruded specific pore volume of the samples were analyzed

| | | Intra-particle intruded | |
|---|---|---|---|
| | | specific pore volume (for | |
| | | the range 0.004-d* μm) | |
| Sample name | d₅₀ (μm) | (cm³/g) | d* (μm) |
| Sample 1 | 8 | | |
| Sample 2 | 8 | | |
| Sample 3 | 12 | | |
| Sample 4 | 12 | | |
| Sample 5 | 2 | | |
| Sample 6 | 11 | | |
| Sample 7 | 12 | | |
| Sample 8 | 3.04 | 0.403 | 0.18 |
| Sample 9 | 1.88 | 0.147 | 0.13 |
| Sample 10 | 3.14 | 0.318 | 0.18 |
| TiO₂ | 0.4 | 0 | — |

### Preparation and testing of décor paper

Different Décor Papers have been Prepared as Follows:

80 g of an oven dry (German term “otro” or “Ofen trocken”) eucalyptus standard pulp with a Schopper Riegler degree of 30° SR and 4.5 g of wet strength agent are diluted in 10 dm³ tap water. Afterwards the respective filler is added in the amount shown in the table below. The obtained suspension is stirred for 10 minutes with a paddle mixer. 15 sheets of 80 g/m² are formed using a Rapid-Kothen hand sheet former available from LGS Senkel, Mühlheim a.d. Ruhr, are formed from each sample.

Each sheet is wet pressed and dried using the Rapid-Kothen drier at 115° C. The composition of the décor paper is given in the table below.

| | | Pulp * | TiO₂ * | Sample 9 | Sample 10 | Sample 8 | Wet strength agent |
|---|---|---|---|---|---|---|---|
| Sample | Invention | [wt.-%] | [wt.-%] | [wt.-%] | [wt.-%] | [wt.-%] | [wt.-%] |
| 11 | No | 70 | 30 | — | — | — | 4 |
| 12 | Yes | 70 | 24 | 6 | — | — | 4 |
| 13 | Yes | 70 | 24 | — | 6 | — | 4 |
| 14 | No | 70 | 24 | — | — | 6 | 4 |

* The sum of the fiber/pulp and the filler always amounts 100 parts by weight. The wet strength agent is added in addition to the 100 parts by weight.

| | | Ry D65 | Opacity | L | a | b |
|---|---|---|---|---|---|---|
| Sample | Invention | D65/10 in % | in % | (white) | (white) | (white) |
| 11 | No | 79.1 | 79.5 | 91.3 | −1.52 | 4.85 |
| 12 | Yes | 79.8 | 80.9 | 91.6 | −1.53 | 4.77 |
| 13 | Yes | 80.2 | 82.4 | 91.8 | −1.52 | 4.75 |

From the above measurements it can be seen that the inventive white UV-absorbing surface-reacted calcium carbonate doped with a titanium. species can be used in paper applications, especially in paper making, for example in décor paper making. Samples 12 and 13 show an improved opacity, improved brightness Rγ and an improved whiteness L* in comparison to sample 11, even if less TiO₂ is present in these décor papers.

Therefore, a part of the titanium dioxide in décor paper, which is a high-priced product can be replaced by the inventive white UV-absorbing surface-reacted calcium carbonate doped with a titanium species and still the décor paper has improved properties like improved opacity, improved brightness Rγ and an improved whiteness L*.

1. A process for producing a white UV-absorbing surface-reacted calcium carbonate doped with a titanium species comprising the steps of:
a) providing a calcium carbonate-comprising material,
b) providing at least one H₃O⁺ ion donor,
c) providing at least one titanium comprising substance, and
d) treating the calcium carbonate-comprising material of step a) with the at least one H₃O ion donor of step b) in an aqueous medium to form an aqueous suspension of surface-reacted calcium carbonate, and
wherein the at least one titanium comprising substance of step c) is added before and/or during and/or after step d).

2. The process of claim 1, wherein the calcium carbonate-comprising material is a natural ground calcium carbonate and/or a precipitated calcium carbonate.

3. The process of claim 1, wherein the calcium carbonate-comprising material is in form of particles having a weight median particle size d₅₀(wt) from 0.05 to 10 μm, and/or a weight top cut particle size d₉₈(wt) from 0.15 to 55 μm.

4. The process of claim 1, wherein the at least one H₃O⁺ ion donor is selected from the group consisting of phosphoric acid, citric acid, an acidic salt, tartaric acid and mixtures thereof.

5. The process of any one of claim 1, wherein the molar ratio of the at least one H₃O⁺ ion donor to the calcium carbonate-comprising material is from 0.01 to 4.

6. The process of claim 1, wherein the at least one titanium comprising substance is selected from the group consisting of a titanium salt, a titanium hydroxide, a titanium dioxide, and mixtures thereof.

7. The process of claim 1, wherein the at least one titanium comprising substance is provided in an amount from 0.1 to 20 wt.-% of titanium element, based on the total dry weight of the calcium carbonate-comprising material.

8. The process of claim 1, wherein in step d) the calcium carbonate-comprising material is treated with a solution comprising the at least one H₃O: ion donor of step b) and the at least one titanium comprising substance of step c).

9. The process of claim 1, wherein in step d) the pH value of the obtained aqueous suspension of surface-reacted calcium carbonate is from 4.5 to 11.

10. The process of claim 1, wherein step d) is carried out at a temperature from 20 to 95° C.

11. The process of claim 1, wherein the process further comprises a step e) of separating the white UV-white absorbing surface-reacted calcium carbonate doped with a titanium species from the aqueous suspension obtained in step d) and/or
wherein the process further comprises a step f) of drying the surface-reacted calcium carbonate doped with a titanium species after step d) or after step e), if present, at a temperature in the range from 60 to 600° C.

12. A white UV-absorbing surface-reacted calcium carbonate doped with a titanium species, comprising calcite and hydroxyapatite and having a specific surface area of from 15 m²/g to 200 m²/g, measured using nitrogen and the BET method according to ISO 9277:2010,
wherein the weight ratio of calcite to hydroxyapatite is from 99:1 to 1:99 based on the dry weight of the calcite and the dry weight of the hydroxyapatite, and
wherein the titanium species is present in an amount from 0.01 to 20 wt.-% of titanium element, based on the total dry weight of the surface-reacted calcium carbonate.

13. The surface-reacted calcium carbonate doped with a titanium species of claim 12, wherein the surface-reacted calcium carbonate doped with a titanium species has
(i) a specific surface area of from 25 m²/g to 180 m²/g, measured using nitrogen and the BET method according to ISO 9277:2010 and/or
(ii) a volume determined median particle size d₅₀(vol) from 1 to 100 μm, and/or
(iii) a volume determined top cut particle size d)s(vol) from 2 to 150 μm,
(iv) an intra-particle intruded specific pore volume in the range from 0.1 to 2.3 cm³/g, calculated from mercury porosimetry measurement.

14. The surface-reacted calcium carbonate doped with a titanium species of claim 12,
wherein the weight ratio of calcite to hydroxyapatite is from 80:20 to 20:80 based on the dry weight of the calcite and the dry weight of the hydroxyapatite, and/or
wherein the titanium species is present in an amount from 0.05 to 15 wt.-% of titanium element, based on the total dry weight of the surface-reacted calcium carbonate.

15. (canceled)

16. (canceled)

17. An article comprising a white UV-absorbing surface-reacted calcium carbonate doped with a titanium species according to claim 12, wherein the article is selected from paper products, engineered wood products, plasterboard products, polymer products, hygiene products, medical products, healthcare products, filter products, woven materials, nonwoven materials, geotextile products, agriculture products, horticulture products, clothing, footwear products, baggage products, household products, industrial products, packaging products, building products, construction products, paints, coatings, sealants, adhesives, feed, cosmetics, water treatment products, catalysis products, gas treatment products, sun protection products for plants and parts thereof, or cosmetic formulations providing chemical or physical sun protection.

18. The process of claim 1, wherein the at least one H₃O⁺ ion donor is phosphoric acid.

19. The process of claim 1, wherein the at least one titanium comprising substance is selected from the group consisting of titanium bromide, titanium fluoride, titanium iodide, titanium chloride, titanyl sulfate, and mixtures thereof.

20. The process of claim 1, wherein step d) is done by solvent evaporation and/or pressure filtration.

21. The surface-reacted calcium carbonate doped with a titanium species of claim 12, wherein the weight ratio of Calcite to hydroxyapatite is from 60:40 to 40:60 based on the dry weight of the calcite and the dry weight of the hydroxyapatite, and/or
wherein the titanium species is present in an amount from 0.5 to 5 wt.-% of titanium element, based on the total dry weight of the surface-reacted calcium carbonate.
